(19) United States
(12) Patent Application Publication
(10) Pub. No.: US 2014/0221071 A1
(43) Pub. Date: Aug. 7, 2014

(54) SYSTEM AND METHOD FOR PLAYING GAMES ON BEHALF OF A PLAYER WITH A PROXY PLAYER SERVER

(71) Applicant: Great Luck, LLC, Winter Park, FL (US)

(72) Inventors: Sam Calio, Altadena, CA (US); Jonathan Eubanks, Palmdale, CA (US)

(73) Assignee: Great Luck, LLC, Winter Park, FL (US)

(21) Appl. No.: 14/171,445

(22) Filed: Feb. 3, 2014

Related U.S. Application Data
(60) Provisional application No. 61/760,358, filed on Feb. 4, 2013.
(60) Provisional application No. 61/817,570, filed on Apr. 30, 2013.

(51) Int. Cl. G07F 17/32

(52) U.S. Cl. CPC G07F 17/3225
USPC 463/19; 463/31; 463/25

(57) ABSTRACT

A proxy system for playing a game on behalf of a player is described herein. The proxy system includes a database for storing a plurality of game request records and a proxy controller that is coupled to the database. The proxy controller is configured to receive, from a player via a user computing device, a first request to play a game, generate an outcome of the game and store the outcome in the database, receive a second request from the player to display a replay of the stored outcome, and generate a game replay indicative of the generated game outcome and display the game replay to the player in response to the second request.

### CROSS-REFERENCES TO RELATED APPLICATIONS

This application claims the benefit of U.S. Provisional Patent Application Ser. No. 61/760,358, filed on Feb. 4, 2013, and claims the benefit of U.S. Provisional Patent Application Ser. No. 61/817,570, filed on Apr. 30, 2013, all of which are hereby incorporated by reference in their entirety for all purposes.

### COPYRIGHT NOTICE

The figures included herein contain material that is subject to copyright protection. The copyright owner has no objection to the facsimile reproduction by anyone of this patent document as it appears in the U.S. Patent and Trademark Office, patent file or records, but reserves all copyrights whatsoever in the subject matter presented herein.

### TECHNICAL FIELD

The subject matter disclosed herein relates generally to a gaming system and more particularly, to a system and method for allowing a player to play a game with a proxy player server.

### BACKGROUND OF THE INVENTION

Casino games such as slot machines, blackjack, and bingo-type games have become a popular activity at casinos and gaming establishments by allowing a person to place real money wagers on the outcome of the games and potentially receive an award based on the outcome of the game, a paytable, and the associated real money wager. At least some known on-line gaming systems allow players to play casino-type games in an on-line environment using non-monetary gaming credits. These known systems attempt to duplicate the casino gaming experience by enabling the players to wager the non-monetary gaming credits on the outcomes of casino-type games. However, because known systems require a player to wager non-monetary gaming credits, the excitement of playing the casino-type game is reduced as compared to real money wagers made on similar casino games played at a casino. Overtime, a player may become frustrated at the limited excitement offered by online gaming systems because the games are played with non-monetary gaming credits. Accordingly, new features are necessary to appeal to players interest in playing on-line casino-type games with real-money wagers to enhance excitement of playing an online casino-type game in order to entice longer play and increased profitability. The present invention is directed to satisfying these needs.

### SUMMARY OF THE INVENTION

The invention is generally directed to systems and methods for authorizing a proxy player system to play games on behalf of a players and for playing bingo-type games on behalf of a player

In one aspect of the present invention, a proxy system for playing a game on behalf of a player is provided. The proxy system includes a database for storing a plurality of game request records and a proxy controller that is coupled to the database. The proxy controller is configured to receive, from a player via a user computing device, a first request to play a game, generate an outcome of the game and store the outcome in the database, receive a second request from the player to display a replay of the stored outcome, and generate a game replay indicative of the generated game outcome and display the game replay to the player in response to the second request.

In another aspect of the present invention, a method of playing a game on behalf of a player via a proxy system is provided. The proxy system includes a proxy controller and a database. The method includes the steps of receiving, from a player via a user computing device, a first request to play a game, generating an outcome of the game and store the outcome in the database, receiving a second request from the player to display a replay of the stored outcome, and generating a game replay indicative of the generated game outcome and displaying the game replay to the player in response to the second request.

In yet another aspect of the present invention, one or more non-transitory computer-readable storage media, having computer-executable instructions embodied thereon is provided. The computer-executable instructions cause the processor to receive, from a player via a user computing device, a first request to play a game, generate an outcome of the game and store the outcome in the database, receive a second request from the player to display a replay of the stored outcome, and generate a game replay indicative of the generated game outcome and display the game replay to the player in response to the second request.

In one aspect of the present invention, a method of allowing a player to play a game with a proxy player server is provided. The method includes receiving, by a proxy player server from a client computing device, a request to play a game, the request including a unique user identifier, and retrieving, by the proxy player server, a list of game types available for play from a game server and displaying the list of game types on the client computing device. The proxy player server receives a user selection input indicative of at least one selected game type from the displayed list of available game types and displays a notification message including a request for a total wager amount to be wagered on one or more games being played by the proxy player server. The proxy player server determines a per-game wager amount based on the total wager amount and the player-selected game type, determines a number of games to be played based on the determined per-game wager amount and the selected game type, and transmits a first request to play a first game of the player selected game-type to the game server. The request including a first wager equal to the determined per-game wager amount. The game server receives the request to play a first game, generates an outcome of the first game, provides an award based on the generated first game outcome and the received first wager, and transmits the award and the outcome to the proxy player server for display to the client computing device. The proxy player displays the generated first game outcome and the associated award, determines a total number of games played and transmits a second request to play a second game of the player selected game-type if the total number of games played is less than the determined number of games to be played. The second request includes a second wager. The game server for receives the second request, generates an outcome of the second game, and transmits the outcome and an associated award to the proxy player server for display on the client computing device.

In another aspect of the present invention, the proxy server may also determine an amount previously wagered and transmit the second play request if the amount previously wagered is less than the requested total wager amount. The proxy server may also retrieve a wager amount associated with each game-type in the list of available game types and select the game-types being displayed on the client computing device based on the requested total wager amount and the wager amounts associated with each game-type. In addition, the proxy server may also determine a user profile associated with the unique identifier. The user profile including a collection of user-defined categories indicative of preferred game-types. The proxy server may also select a plurality of game-types from the list of available game-types based on the user-defined categories and display the selected preferred game-types in response to the user request.

In yet another aspect of the present invention, the proxy server may transmit a client computing device location verification request to a watchdog server including a unique location identifier associated with the client computing device. The watchdog server may determine if the unique location identifier is included in a collection of authorized location identifiers and responsively transmit a verification message if the received unique location identifier is included in the collection of authorized location identifiers. The proxy player server may also retrieve and display the list of available game types upon receiving the verification message. The proxy player server may also transmit a harmful activity verification request including the received total wager amount and the selected game-type to the watchdog server. The watchdog server may determine a number of play requests received over a predefined period of time and responsively transmit a harmful activity notification message to the proxy player server if the number of play requests is greater than a predefined number of play requests over the predefined period of time.

In one aspect of the present invention, the proxy player server may also transmit a funds verification request including the total wager amount and the unique user identifier to an e-wallet server. The e-wallet server may determine a gaming account associated with the unique user identifier and an amount of available funds included in the gaming account, determine if sufficient funds are available in the gaming account to fund the requested total wager amount, and responsively transmit a verification message to the proxy player server if sufficient funds are available in the gaming account to fund the requested total wager amount. The e-wallet server may also transmit a funding request including the unique user identifier and a funding amount to a financial account server if the gaming account does not include sufficient funds. The funding amount may be determined as a function of the available gaming account funds and the requested total wager amount.

In another aspect of the present invention, a proxy player server for playing a game for a player is provided. The proxy player server includes a processor that is connected to one or more client computing devices. The proxy player server receives, from a client computing device, a request to play a game, the request including a unique user identifier. The proxy player server retrieves a list of game types available for play from a game server and displays the list of game types on the client computing device. The proxy player server receives a user selection input indicative of at least one selected game type from the displayed list of available game types and displays a notification message including a request for a total wager amount to be wagered on one or more games being played by the proxy player server. The proxy player server determines a per-game wager amount based on the total wager amount and the player-selected game type, determines a number of games to be played based on the determined per-game wager amount and the selected game type, and transmits a first request to play a first game of the player selected game-type to the game server. The game server receives the request to play a first game, generates an outcome of the first game, provides an award based on the generated first game outcome and the received first wager, and transmits the award and the outcome to the proxy player server for display to the client computing device. The proxy player server determines a total number of games played and transmits a second request to play a second game of the player selected game-type if the total number of games played is less than the determined number of games to be played.

In yet another aspect of the present invention, a system for allowing a player to play a game with a proxy player server is provided. The system includes a game server that includes a plurality of game-types, a plurality of client computing devices, and a proxy player server coupled to each client computing device of the plurality of client computing devices. The proxy player server receives, from a client computing device, a request to play a game, the request including a unique user identifier. The proxy player server retrieves a list of game-types available for play from the game server and displays the list of game types on the client computing device. The proxy player server receives a user selection input indicative of at least one selected game type from the displayed list of available game types and displays a notification message including a request for a total wager amount to be wagered on one or more games being played by the proxy player server. The proxy player server determines a per-game wager amount based on the total wager amount and the player-selected game type, determines a number of games to be played based on the determined per-game wager amount and the selected game type, and transmits a first request to play a first game of the player selected game-type to the game server. The game server receives the request to play a first game, generates an outcome of the first game, provides an award based on the generated first game outcome and the received first wager, and transmits the award and the outcome to the proxy player server for display to the client computing device. The proxy player server determines a total number of games played and transmits a second request to play a second game of the player selected game-type if the total number of games played is less than the determined number of games to be played.

### BRIEF DESCRIPTION OF THE DRAWINGS

Other advantages of the present invention will be readily appreciated as the same becomes better understood by reference to the following detailed description when considered in connection with the accompanying drawings wherein:

FIGS. 1 through 7 are schematic representations of an exemplary system, according to an embodiment of the present invention;

FIGS. 8 and 9 are flowcharts of a method that may be used with the system shown in FIGS. 1-7 for allowing a player to create a user profile account to allow the player to request a proxy player server to play games on behalf of the player;

FIG. 10 is a flowchart of a method that may be used with the system shown in FIGS. 1-7 for allowing a player to authorize a proxy player server to play games on behalf of the player;

FIG. 11 is schematic representation of a proxy player server that may be used with the system shown in FIGS. 1-7, according to an embodiment of the invention;

FIG. 12 is a flowchart of a method that may be used with the system shown in FIGS. 1-7 and FIG. 11 for allowing a player to request a proxy player server to play a game on behalf of the, according to an embodiment of the invention;

FIG. 13 is a graphical display of a registration screen that may be used with the methods shown in FIGS. 8-10 and 12, according to an embodiment of the present invention;

FIG. 14 is a graphical display of a game request screen that may be used with the method shown in FIGS. 8-10 and 12, according to an embodiment of the present invention;

FIG. 15 is a graphical display of a game list screen that may be used with the method shown in FIGS. 8-10 and 12, according to an embodiment of the present invention;

FIG. 16 is a graphical display of a game progress screen that may be used with the method shown in FIGS. 8-10 and 12, according to an embodiment of the present invention;

FIG. 17 is a graphical display of a competed games screen that may be used with the method shown in FIGS. 8-10 and 12, according to an embodiment of the present invention; and

FIG. 18 is a graphical display of a game replay screen including an exemplary entertaining graphical display of a bingo-type game that may be used with the method shown in FIGS. 8-10 and 12, according to an embodiment of the present invention.

Corresponding reference characters indicate corresponding parts throughout the drawings.

### DETAILED DESCRIPTION OF THE PREFERRED EMBODIMENT

With reference to the drawings and in operation, the present invention overcomes at least some of the disadvantages of known systems by providing an online casino system that enables a user to play Class II game with real money wagers using a mobile computing device. More specifically, the system includes a game server including a plurality of casino-type games, a proxy player server for playing the casino-type games on behalf of a player, and a plurality of remote client computing devices that are connected to the proxy player server to enable a player to access the proxy player server to instruct the proxy player server to play a game on behalf of the player. Moreover, the proxy player server displays the plurality of available games to the player, receives a wager from the player, and transmits the wager to the game server to initiate play of the game. The game server generates the game outcome and any associated award and transmits the outcome and the award to the proxy server for display to the player.

In the illustrated embodiment, the proxy player server is configured to receive a request from a player to play a game and responsively play the game on behalf of the player. In addition, the proxy player server may generate a game replay that is indicative of the played game. Moreover, the proxy player server may also allow the player to select the game replay to view a simulation of the game that have been previously played on behalf of the player after the game has been played by the proxy player server. The game replay includes images and animations that simulate the game played by the proxy player server. In one embodiment, the proxy player server may allow a player to submit a game request that includes a plurality of game preferences such as, for example, a game denomination, a game type, and/or a number of bingo cards. The proxy player server may match the received game request with a game request associated with another player as a function of the game preferences, and initiate a game that includes the matched players. In addition, the proxy player server may allow the player to select a game theme for use in generating the game replay. By providing a proxy player server that plays a game on behalf of a player and generates a game replay that simulates the played game, the player is allowed to remotely play Class II games with real money wagers via a mobile device and/or a website, and the excitement and interest of the player is increased, thus increasing an amount of revenue provided to the Class II gaming operator.

The proxy system ensures that all traffic passing through all proxy sub-components are 100% compliant with ensures compliance with all applicable gaming regulations, for example National Indian Gaming Commission (“NIGC”) regulations NIGC §547. All Internet packets and communication between the Game Server, Financial Server, CRM, Watchdog, etc., are all compliant with all applicable gaming regulations.

All components communicate via a set of application programming interface (API) provided by the Proxy. All parameters in the API are logged accordingly and are compliant with all applicable gaming regulations.

The Proxy in essence enforces all of applicable gaming regulations and is the final autonomous authority within the Proxy system.

In the illustrated embodiment, the proxy player server and the game server are each located within an approved gaming jurisdiction such as, for example, within sovereign Indian tribal lands, to enable the game server to accept a wager from the proxy server located within the approved gaming jurisdiction, to play the requested game, and provide the associated award to the proxy player server. By providing a gaming system that enables players to place real-money wagers on casino-type games using a proxy player server, the excitement of playing an online casino-type game is improved.

In general, the system 10 includes a server system and a plurality of client computing devices that are connected to, and remotely located from, the server system for playing a plurality of wagering games to enable players to play Class II games via remote gaming terminals. The server system includes a plurality of game servers that include the wagering games, a web server to facilitate remote access between the server system and the client computing devices, and a proxy player server that is connected to the game servers and the client computing devices for playing the wagering games based on input received from the client computing devices. The game servers include all gaming software modules including random number generators for performing the games on the game servers. The client computing devices do not include any gaming software, and are configured to enable a player to access the central system and to display gaming outcomes received from the proxy player server on the client computing devices. By providing a gaming system that enables players to place real-money wagers on casino-type games using a proxy player server, the excitement of playing an online casino-type game is improved.

In the illustrated embodiment, the system 10 also includes a financial account server for creating a player gaming account and for storing players funds for use in playing games. The financial account server communicates with a players financial institution to transfer funds from a player's bank account to the player's gaming account. The system 10 also includes a watchdog server for verifying player age and location, and monitoring player gaming behavior to identify harmful gambling behavior. In the illustrated embodiment, the game servers, proxy player server, player financial account server, and watchdog server are located on approved sovereign land such as, for example approved sovereign tribal lands. In another embodiment, the game servers, proxy player server, player financial account server, are each located within the same jurisdiction, within a plurality of separate jurisdictions, and/or within any suitable location and/or facility that enables the system 10 to function as described herein. In addition, the remote client computing devices may be located on approved tribal lands to access games located on the gaming server.

The system 10 may also include player preferences for use in determining game play. For example, the system 10 may receive players preferences for playing a plurality of games, select a game based on the received player preferences, and play the game in accordance with the player preferences.

The system 10 may also include location verification of client computing devices. For example, the system 10 may also verify the location of a gaming server and player computing device, and enable the player to request the system to play a game on the gaming servicer if the gaming server and player device are located within approved locations (tribal lands). The system 10 may also include a proxy financial account (e-wallet). For example, the system 10 may also create a proxy financial account, transfer funds from a user financial account to the proxy financial account, and transfers funds from the proxy financial account to a game server. The e-wallet financial account is located within approved locations, i.e. tribal lands.

The system 10 may also include problem gambling detection. For example, the system 10 may also identify a problem gambler based in part on a number of times a wager is requested without sufficient funds, and provide notification to the player, and restricts the player from playing the game based on the repeated wagering requests.

In the illustrated embodiment, during operation, a player uses the client gaming terminal to access a server system 12 via a Great Luck website interface. The player selects the desired Class II games to be played by the proxy server, and indicates the level of buy-in for each game selected. The player authorizes the proxy server to play the games at the buy-in level indicated on behalf of the player. The proxy server transmits a wager to the gaming server to initiate the selected game. The gaming server randomly generates the outcome of the wagered game and reports the outcome to the proxy server. The proxy server transmits the game outcome to the client gaming terminal that displays the game outcome to the player.

The Great Luck system 12 is the provider of the premier next-generation online game environment, where in a fully browser based 3-D virtual world, users create and control avatars to experience social network interactions, community happenings, entertainment, e-commerce and certain gambling or gaming related activities. Users of the Great Luck system 12 Internet site will play in a “virtual world” on the site—which, among many other features, will contain a “portal” to certain gaming activities conducted in a licensed gaming facility located on the sovereign lands such as, for example, a sovereign Indian land of the tribe operating the gaming portal. The user will be able to access the gaming experience through Great Luck Remote Access Bingo System 12 (RAB System), specially designed to comply with applicable federal law.

The primary feature of the RAB System 12 is the use of a secure and restricted access VPN which will allow customers accessing the virtual world offered on the Internet by the Great Luck website to play Class II games through the use of a proxy player on their computers or mobile devices from any location within any jurisdiction where the use of the Internet to play or access Class II games is not prohibited. The RAB System 12 utilizes a secure VPN for the communications link between the remote player and the server-based games residing on the server located on sovereign lands of the tribe operating the gaming portal as part of the Great Luck virtual world. The secure VPN used by the RAB System 12 is in essence a “closed, proprietary communication network”. A closed proprietary network, more commonly known as a “private network”, is separate and distinct from the “Internet” through its use of VPNs. The VPN to be used as part of the RAB System 12 is designed to only allow access to customers on either end of the communication connection with the tribal gaming facility operating the gaming portal. This point-to-point (or tribal gaming facility-to-player) communication connection is segregated from the Internet. This level of isolation is accomplished by using various technologies that not only establish the “tunnel” for the information passed between the tribal gaming facility and remote players, but also how the information is transported.

In the illustrated embodiment, the server system 12 includes: 1) Firewall(s): a security system consisting of a combination of hardware and software that limits the exposure of a computer or computer network to attack from hackers; commonly used on local area networks that are connected to the Internet; 2) IPSec: Internet Protocol Security provides interoperable, high quality and cryptographically based security services for traffic at the IP layer, such as authenticity, integrity, confidentiality and access controller to each IP packet; 3) Password Authentication: end user security measure that ensures user login and identification are based on a unique Great Luck number, login name and password combination. Further authentication techniques may be utilized to further enhance security through use of physical characteristics such as fingerprint identification, iris/retinal scanning, facial scanning and recognition, voice recognition, etc. The server system 12 may also include 4) Advanced Encryption: A cryptographic algorithm that can be used to protect electronic data. The AES algorithm can be used to encrypt (encipher) and decrypt (decipher) information. Encryption converts data to an unintelligible form called ciphertext. Decrypting the ciphertext converts the data back in to its original form, called plain text.

The RAB System 12 may also include age and location verification requirements reasonably designed to block access to minors and persons located outside of the sovereign Indian Lands of the tribe operating the gaming portal as part of the Great Luck virtual world, and appropriate data security standards to prevent unauthorized access by any person whose age and current location has not been verified. No minors will be allowed to access the RAB System 12 and players may be located somewhere within any jurisdiction where the use of the Internet to play or access Class II games is not prohibited.

The Class II games that will be first offered for play on the RAB System 12 include, but are limited to, games which commonly use some form of “technological aid”, like bingo-based video games, video “scratch-offs” type games and electronic instant lotto.

The RAB System 12 will comply with the Part 547 technical standards for the use of “technological aids” in the play of Class II games. The primary collection of components that serve as “technological aids” as part of the play of Class II games using the RAB System 12 consist of the following: 1. The electronic hardware & software components used to make a “video” or “digital” representation of the Class II game on the remote player's computer, mobile device, or other device that allows access to the Internet; 2. The hardware & software components used to make the VPN communication link between the servers located on sovereign lands of the tribe operating the gaming portal and the remote player's computer or mobile device; and 3. The “Proxy Player” electronic device that allows the remote player to interact with and instruct a person located on the sovereign lands of the tribe operating the gaming portal how to complete the game play of the remote player.

In summary, this collection of “technological aids” allows the RAB System 12 to function as follows: (1) the electronic hardware & software components will permit a video or digital representation of the Class II game play and results to be displayed to the remote player using the RAB System, allowing the player to see and the Class II game the same as he would if he had played an “electronic” Class II gaming device at the tribal gaming facility itself; (2) the VPN hardware & software components will permit a remote communications channel between the remote player and the “Proxy Player” device located on sovereign Indian lands of the tribe operating the gaming portal and monitored by a person, also located thereon, who will receive instructions from the remote player as to how to execute the betting transaction and complete play of the game; and (3) the “Proxy Player” device will allow the device monitor to receive instructions from the remote player regarding how to execute the betting transaction and complete play of the game such that the “Proxy Player” device monitor will play in real time on the remote player's behalf at the tribal gaming facility; using a proxy player device component supplied by a gaming equipment manufacturer whose electronic hardware and software has been expressly developed to adhere to the Jul. 26, 1995 “proxy player” opinion issued by the NIGC and which does not change the essential game characteristics or statutory criteria required under IGRA for the play of the Class II game offered for remote play to customers using the RAB System 12. In one embodiment, the system 10 allows the user submits a request form to the Proxy on sovereign Indian land. The request form may include information such as, for example, number of games, number of cards per game and what theme is desired. Once the form is submitted, the user can go home or come back in a day or two. No real-time interaction is required by the user. In one embodiment, the system 10 may prohibits any real-time interaction by the user. The submission form is accepted by the Proxy Agent on sovereign Indian land and placed in a database queue until the Game Service accesses it. At that point, all monetary transactions take place on behalf of the player and once cleared by the Proxy Game Service the game logic proceeds and the games get played out by the Proxy on sovereign Indian land after some time had passed. Also, no games can start for any denomination unless there are a minimum of 2 players according to Class II requirements. In one embodiment, the minimum number can be greater than 2 players but never less. All games results are saved and logged by the Proxy and all user specific data is stored in the user's account database. At that point it is made available to the user when he/she is ready to view the game results as they had occurred some time ago.

In one embodiment, the server system 12 may include will consist of four servers, three of which will be located on the sovereign lands of an Indian tribe or tribes that are eligible for gaming pursuant to the Indian Gaming Regulatory Act (IGRA). The player, who will not be required to be located on sovereign lands, logs on to the Great Luck server which will not necessarily be located on sovereign lands. The player agrees to Great Luck terms of use and becomes a member. The player enters certain demographic and personal information and completes the e-Wallet account process. Great Luck server verifies the information provided to determine the eligibility of the player.

If the player is not eligible, the process ends and the player will not be able to participate in the bingo game. If the player is eligible, he or she authorizes the establishment of a financial account pursuant to tribal regulations through a financial server located on sovereign lands. The eligible player then authorizes and appoints a proxy player pursuant to tribal regulations through a proxy server located on sovereign lands. Through the Great Luck server the player enters bingo play preferences and submits those preferences to the proxy server. The financial server withdraws funds from the player's e-wallet account on the Great Luck server. If there are sufficient funds available, the proxy withdraws funds from the player's account on the financial server. Pursuant to tribal regulations, the proxy then registers the player's account on the game server which is located on sovereign lands. The proxy then selects the bingo games to be played based on the player's preferences. The proxy purchases bingo cards from the game server based on the player's preferences. The proxy then joins the next available game on the game server.

The bingo-type game is played in accordance with the IGRA and National Indian Gaming Commission (“NIGC”) regulations. The player witnesses the proxy play bingo game, but does not participate in the game. The proxy automatically covers the bingo cards when the player's numbers are called. If the player wins, the proxy declares a bingo and notifies the player of the game results. The proxy asks the player if he or she wished to continue play. If the player does not wish to continue play, the proxy deducts losses or adds winnings to the amount originally withdrawn from the financial server. The proxy then deposits winnings into player's account on the financial server. In turn, the financial server deposits winnings from the proxy into the player's Great Luck e-wallet account.

A selected embodiment of the present invention will now be explained with reference to the drawings. It will be apparent to those skilled in the art from this disclosure that the following description of the embodiment of the present invention is provided for illustration only and not for the purpose of limiting the invention as defined by the appended claims and their equivalents.

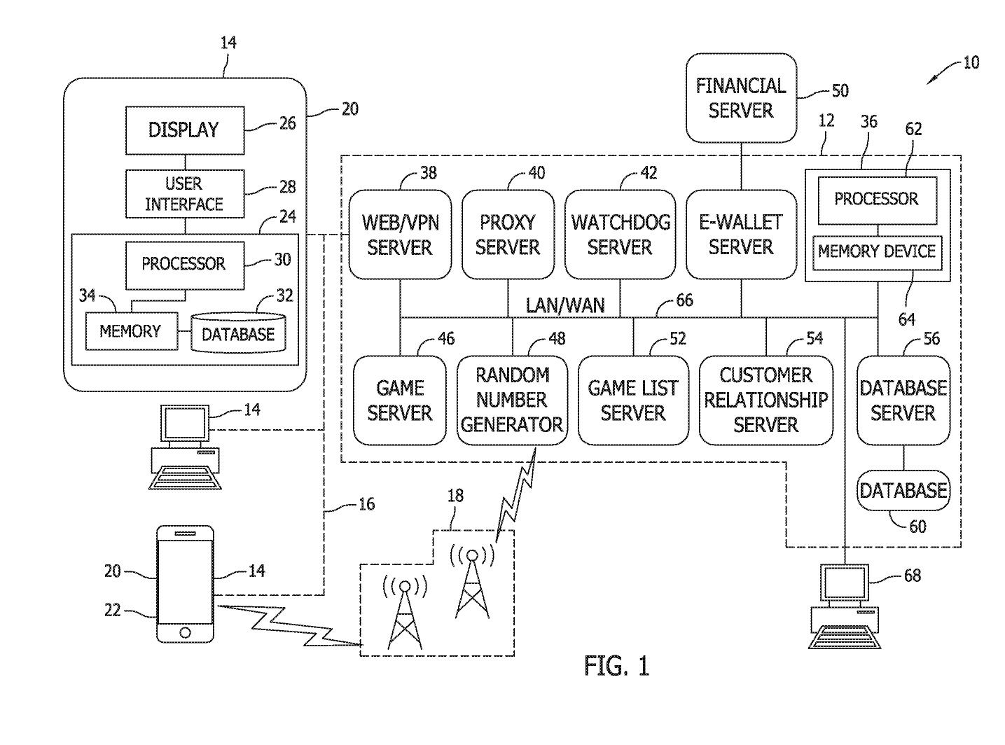

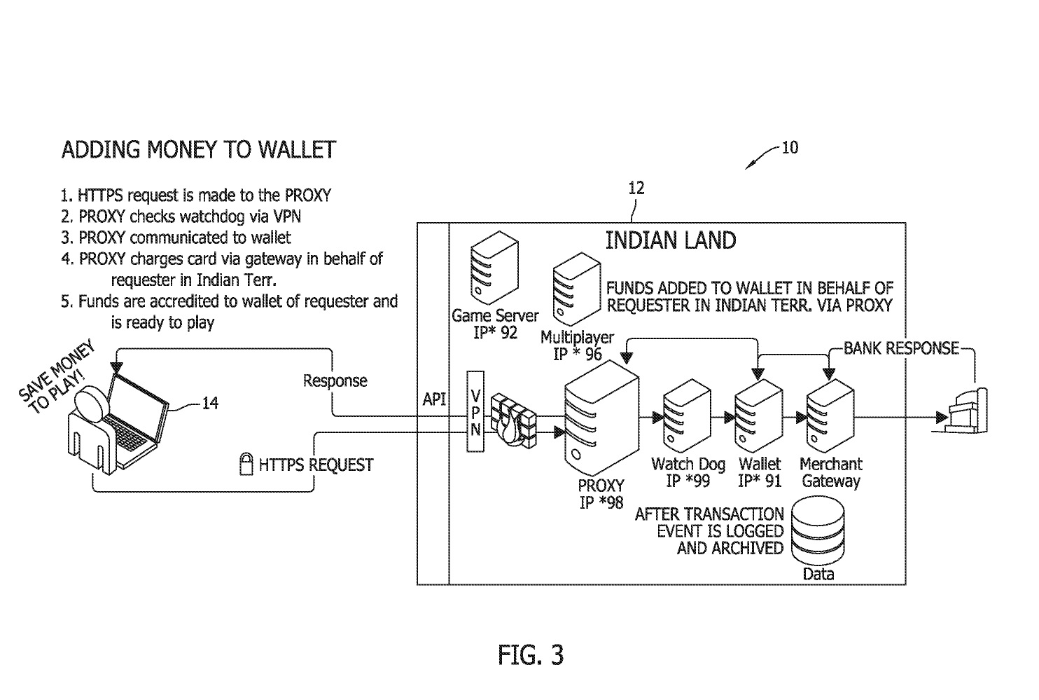

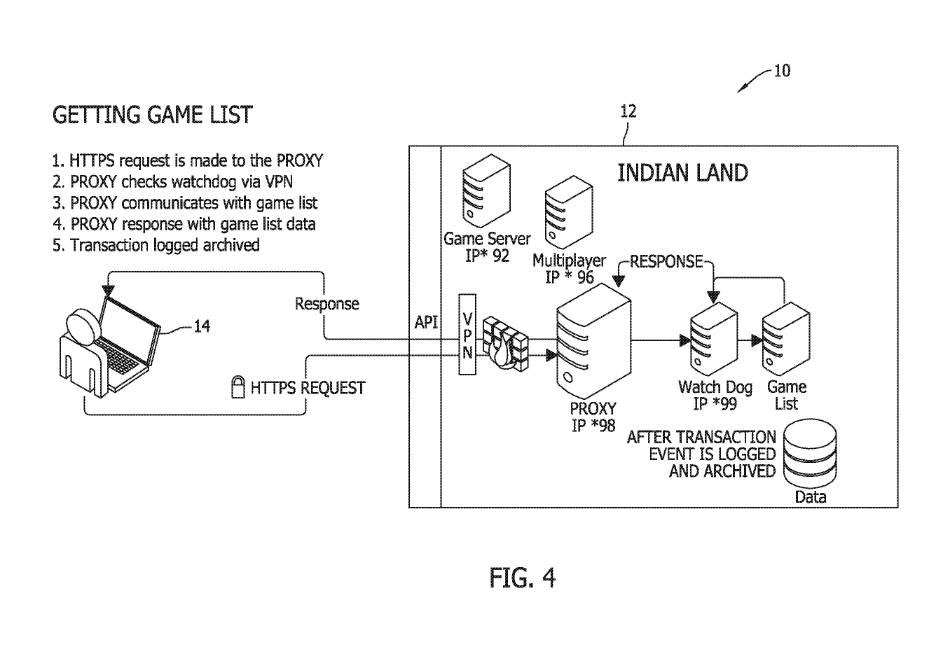

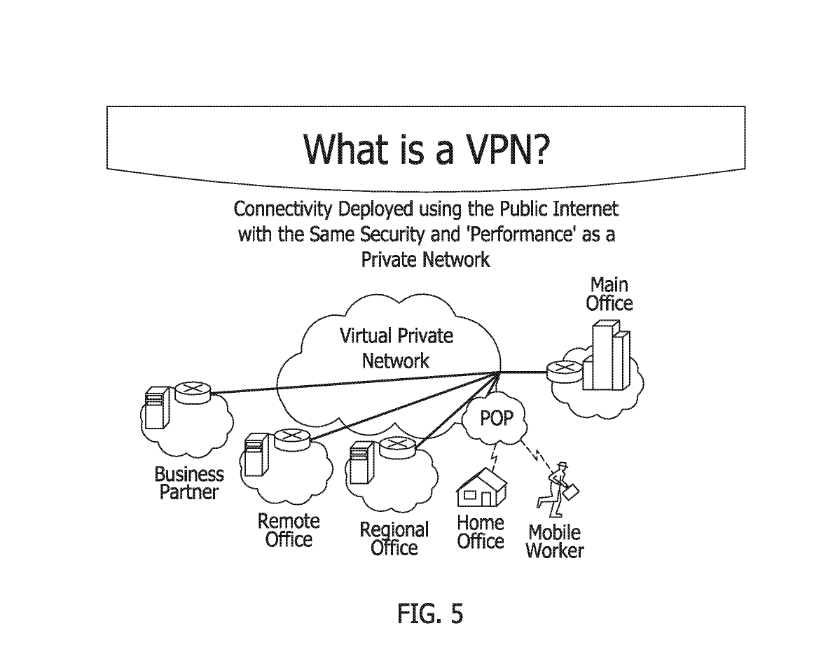

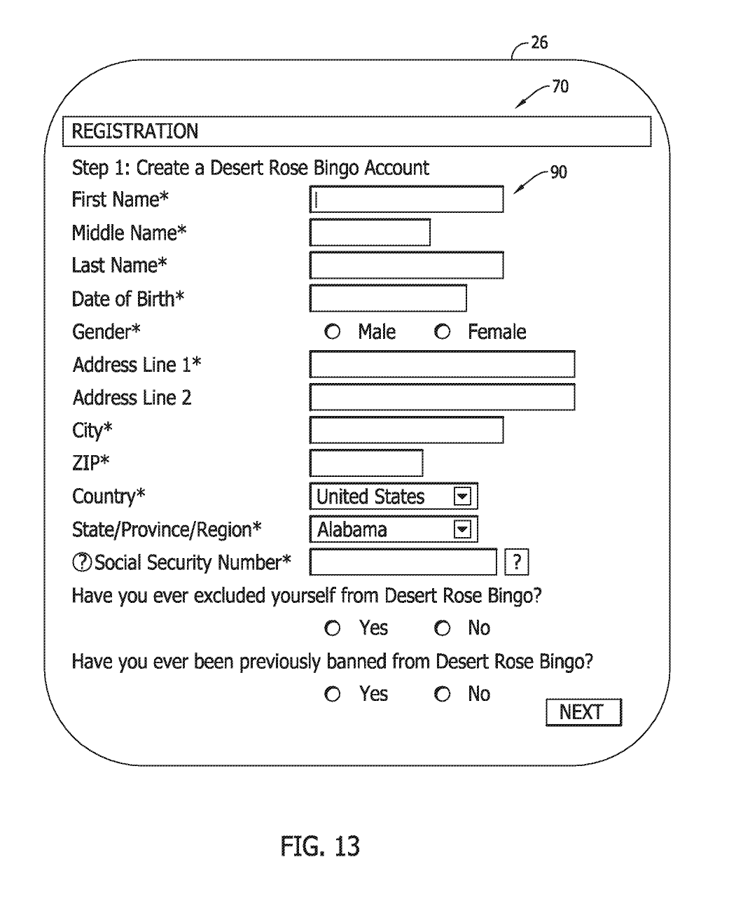

FIGS. 1-5 are schematic representations of the system 10, according to an embodiment of the present invention. In the illustrated embodiment, the system 10 includes a server system 12 that is coupled to one or more client computing devices 14. Each client computing device 14 is configured to transmit and receive data to and/or from the server system 12 to display graphical interfaces (shown in FIGS. 13-17) to enable a player to play a game on the system 10 via the client computing device 14. In the illustrated embodiment, the server system 12 is coupled to each client computing device 14 via a communications link that enables each client computing device 14 to access server system 12 over a network, such as the Internet 16, a cellular network 18, a wireless network and/or any suitable mobile telecommunication network that enables the client computing devices 14 to access the server system 12. For example, in one embodiment, the client computing device 14 includes a mobile computing device 20, e.g. a smartphone 22 that communicates with the server system 12 via the cellular telecommunications network 18 and/or the Internet 16. In another embodiment, the client computing device 14 may include a personal computer, laptop, cell phone, tablet computer, smartphone/tablet computer hybrid, personal video gaming device, personal data assistant, and/or any suitable computing device that enables a player to connect to the server system 12.

In the illustrated embodiment, each client computing device 14 includes a controller 24 that is coupled to a display device 26 and a user input device 28. The display device 26 includes, without limitation, a flat panel display, such as a cathode ray tube display (CRT), a liquid crystal display (LCD), a light-emitting diode display (LED), active-matrix organic light-emitting diode (AMOLED), a plasma display, and/or any suitable visual output device capable of displaying graphical data and/or text to a user. Moreover, the user input device 28 includes, without limitation, a keyboard, a keypad, a touch-sensitive screen, a scroll wheel, a pointing device, a barcode reader, a magnetic card reader, a radio frequency identification (RFID) card reader, an audio input device employing speech-recognition software, and/or any suitable device that enables a user to input data into the controller 24 and/or to retrieve data from the controller 24. Alternatively, a single component, such as a touch screen, a capacitive touch screen, and/or a touchless screen, may function as both the display device 26 and as the user input device 28.

In the illustrated embodiment, the controller 24 includes a processor 30, a database 32, and a memory device 34 that is coupled to the processor 30 and the database 32. The memory device 34 includes a computer readable medium, such as, without limitation, random access memory (RAM), read-only memory (ROM), erasable programmable read-only memory (EPROM), flash memory, a hard disk drive, a solid state drive, a diskette, a flash drive, a compact disc, a digital video disc, and/or any suitable device that enables the processor 30 to store, retrieve, and/or execute instructions and/or data.

In general, the server system 12 allows for a method to technically and legally act on behalf of a player to place bets and make any Bingo-type related transactions possible from a remote location. This method encompasses a collection of subsystems, including hardware and software, collectively working together in support of the ‘Proxy’. The Proxy, being the main point of entry and exit into sovereign Indian land, is the focus of all transactions and the conduit between all subsystems and servers.

In the illustrated embodiment, the server system 12 include a system controller 36, a web/vpn server 38, a proxy player server 40, a watchdog server 42, an e-wallet server 44, a game server 46, a random number generator 48, a financial server 50, a game list server 52, a customer relationship server 54, a database server 56, and a database 60.

The system controller 36 includes a processor 62 and a memory device 64, and communicates with each client computing device 14 to enable the user to access the server system 12. The system controller 36 is connected to the servers, and the database 60 through a network 66 such as, for example, a local area network (LAN), a wide area network (WAN), dial-in-connections, cable modems, wireless modems, and/or special high-speed Integrated Services Digital Network (ISDN) lines. An administrator workstation 68 is also coupled to the network 66 to enable communication with the server system 12. Alternatively, the workstation 68 may be coupled to the network 66 using an Internet link or may be coupled through an intranet.

The processor 62 executes various programs, and thereby controls other components of the system controller 36 and the client computing device 14 according to user instructions and data accepted by the user input device 28. The processor 62 in particular displays a graphical interfaces (shown in FIGS. 13-17), and thereby enables the system 10 to generate images and games in response to user instructions received via the client computing devices 14 in accordance with the embodiments described herein. The memory device 64 stores programs and databases used by the processor 62. Moreover, the memory device 64 stores and retrieves information in the database 60 including, but not limited to, image data for producing images and/or screens on the display device 26, and temporarily stores variables, parameters, and the like that are used by the processor 62.

The server system 12 may also include, but is not limited to, Linux CentOS Distribution (SERVER), MySQL (Relational Database), MongoDB (Document Object Database), Memecached (Query Caching), APC Caching (Caching), REST API (Application Program Interface), and/or MVC Framework (Model View Controller Framework).

In the illustrated embodiment, the proxy player server 40 acts as an intermediary for requests from players seeking Bingo-type games and related actions hosted on sovereign Indian land. For example, a player may connect to the proxy player server 40, request some service, such as placing a bet, spin the wheels, transfer money, and/or other gaming related resource available on sovereign Indian land.

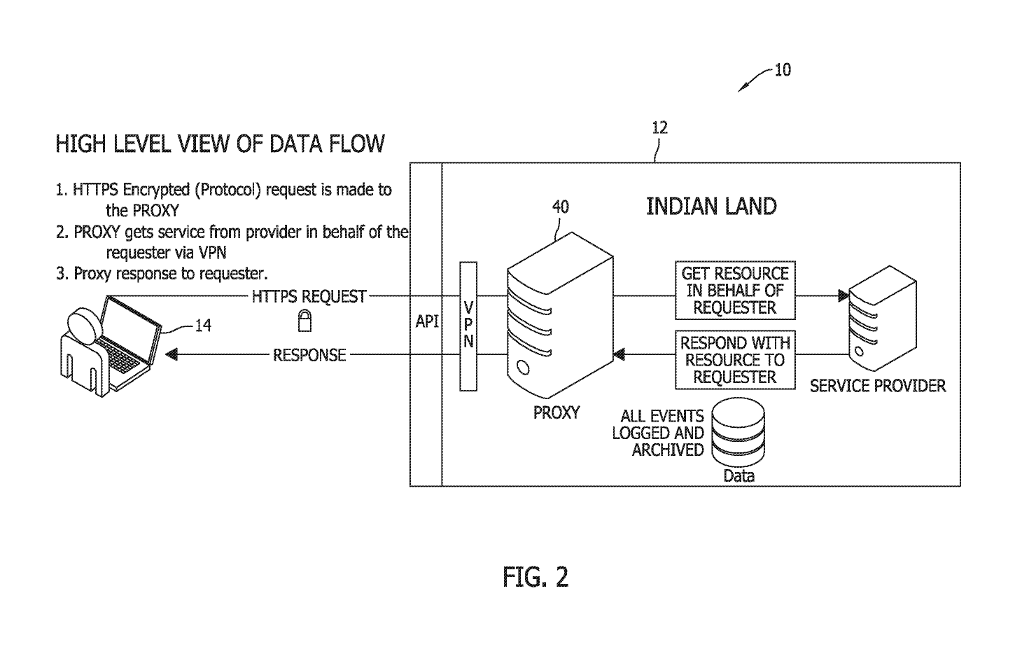

The proxy player server 40 evaluates the request as a way to simplify, control and comply with Class II gaming regulations. The proxy player server 40 in return passes results and animation data that have been played out on sovereign Indian land back to the player as if the player were physically on Native Indian land casino. FIGS. 2-4 also illustrate example of embodiments of the present invention that enable a player to request to see a list of possible Bingo-type games to play.

The game server 46 is responsible for tracking all open sessions with all players and keeps track of all game data including winnings and scores. The game server 46 includes a multi-platform client/server technology designed to integrate with the major online web and mobile technologies (Adobe Flash, Unity, iOS, Android, HTML5) created for multiuser experiences of all scales. The game server 46 is highly optimized to provide multiplayer games and provides powerful tools for the creation of real-time multiplayer games, MMOs, virtual communities and much more. The game server 46 is based on a custom high-performance and scalable architecture that can handle tens of thousands of clients even on commodity hardware. The game server 46 also provides integrated and optimized support for connecting the database 60, a fast and highly optimized network protocol with auto-compression, HTTP tunneling for clients behind the Proxy and firewalls, embedded HTTP server for all web content.

The game list server 52 includes a plurality of game types including, but not limited to, Bingo-type games and Class II Games. The game list server 52 provides the Class II games to the game server 46 and/or may be part of the game server 46. The game list server 52 may also be on the same physical server as the game server 46. The server system 12 also enables 3^{rd} party developers and gaming providers to access the game server 46 via a set of Application Programming Interface (API) in the way they connect to the overall Proxy architecture. This subsystem is important and may adhere to Class II Gaming Regulations. For example, in one embodiment, gaming provides may access the server system 12 via the administrative workstation 68 to upload and/or modify games and/or gaming content contained on the game server 46 and/or the game list server 52.

The random number generator 48 generates and outputs random numbers to the game server 46 for use in generating game outcomes of the game-types. For example, in one embodiment, upon receiving a wager request from the proxy player server 40, the game server 46 requests random numbers from the random number generator 48 preferably at the start of each round of game. The game server 46 uses the random numbers to determine an outcome of the requested games. Moreover, the game server 46 generally uses random numbers generated by the random number generator 48 to play the requested games, and to determine whether or not to provide an award based on the outcome of each game. In addition, in one embodiment, the game server 46 may generate game outcomes including combinations of random numbers, and compare the generated combinations with winning combinations stored in the winning combination table to determine if the generated outcome is a winning outcome that is associated with a type of award. In general, the term “award” may be a payout, in terms of credits or money. Thus, game server 46 may award a regular payout in response to the outcome of the games. However, it should be noted that the term award may also refer to other types of awards, including, prizes, e.g., meals, show tickets, etc. . . . , as well as in-game award, such as free games.

The web/vpn server 38 communicate with the client computing devices 14 to facilitate transmitting data over the network via the Internet 16 and/or the cellular network 18, respectively. Moreover, the web/vpn server 38 receives a request to access the server system 12 from a client computing device, and generates a secured virtual private network (VPN) within the network to facilitate secured communication between the server system 12 and the client computing device 14 as described herein.

The database server 56 is connected to the database 60 containing information on a variety of matters, such as, for example, account information related to a user, user profile information, and/or game information. In one embodiment, the database 60 includes a centralized database that is stored on server system 12 and is accessed directly via the client computing devices 14. In an alternative embodiment, the database 60 is stored remotely from the server system 12 and may be non-centralized. In the illustrated embodiment, the database 60 includes a user profile program that includes a plurality of user profile accounts and a plurality of corresponding unique user identifiers. For example, in one embodiment, the unique user identifier may include a combination of a username and password. Alternatively, in another embodiment, the unique user identifier may include a personal identification number, or a random identification number assigned to a corresponding user account. In the illustrated embodiment, the system 10 uses the unique user identifier to identify the user and provide access to the server system 12 via a client computer device 14 associated with the unique user identifier. For example, in one embodiment, the unique user identifier may include a mobile device identifier, such as, for example, a cellular phone number and/or wireless internet address for identifying a client computing device 14 associated with a user account. In addition, the database 60 may also contain information on a variety of matters, such as, for example, account information related to a user, user profile information, a game type, a number of game symbols associated with a game, a number of bingo symbols associated with a game, a type of bingo symbol, an amount of symbol positions groups associated with a game, a plurality of bingo cards for use in a bingo-type game, and image data for producing game images and/or screens on the client computing device 14.

The database 60 may also stores all user data, stores all game related statistics and content, store all CRM related transactions and data, and store all CMS (Content Management System) related data. All sensitive data is encrypted before being stored. The database 60 may be outside sovereign Indian land.

Each user profile account includes personal identification information such as, for example, a user name, address, personal identification number, email address, mobile phone number, and/or any suitable information that enables the system 10 to identify a user. In one embodiment, the user profile account may include a collection of user-defined categories that are indicative of preferred game-types. For example, in one embodiment, the user profile account may include a list of preferred game-types, wager amounts, paytables, number of games, and/or any suitable event category identified by the associated user. In addition, the user profile account may include player tracking information such as, for example, a type of game previously played by the player, a frequency in which the player plays a game, the average number of games played over a predefined period of time, the average credit wager the player makes per play of a game, a total amount wagered by the player over a predefined period of time, and/or any other suitable player tracking information. In addition, the user profile account may also include a list of preferred game categories such as, for example, type of games, amount of wagers made per game, number of games to be played simultaneously, total amount of wagers made during gaming session, and/or any information related to a preferred game environment that enables the system 10 to function as described herein.

In the illustrated embodiment, each user profile account also includes financial account information associated with each user. The financial account information may include, but is not limited to, an amount of game credits available for use in playing games, available monetary funds for use in purchasing game credits, an available game credit account balance, and/or any suitable financial information that enables the system 10 to function as described herein.

The financial server 50 includes financial account information associated with each user profile account. The e-wallet server 44 is an extension of the financial server 50 (the FS is outside sovereign Indian land), which is responsible for holding funds that have been transferred via the proxy player server 40 on behalf of the player from the financial server 50. The e-wallet server 44 includes a gaming account that is associated with the player. The proxy player server 40 determines if there are enough funds in the e-wallet before each game. If there are no funds in the e-wallet and depending on the user's settings, the proxy player server 40 may transfer funds from the financial server 50 in order to deposit in the user's e-wallet on sovereign Indian land.

The customer relationship server 54 (the CRM server) is responsible for managing the interactions with customers, clients, and sales prospects. The CRM server 54 includes technology to organize, automate, and synchronize business processes, principally sales activities, but also those for marketing, customer service, and technical support. The overall goals are to find, attract, and win new clients, nurture and retain those the company already has, entice former clients to return, and reduce the costs of marketing and client service. The CRM server 54 is a separate but important part of data and content management. The CRM server 54 can be managed and hosted outside of the server system 12 environment.

In the illustrated embodiment, the workstation 68 includes a display and user input device to enable an administrative user to access the server system 12 to transmit data indicative of the game and/or awards to the database server 56. This enables an administrative user to periodically update the game list, game types, user profile accounts, and/or any suitable data and information that enables the system 10 to function as described herein.

In the illustrated embodiment, during operation, the proxy player server 40 receives a request to play a game from a player via a client computing device 14. The request includes a unique user identifier associated with the player. In response to the received request, the proxy player server 40 retrieves a list of game types available for play from the game server 46 and displays the list of game types on the client computing device 14 and receives a player's selection input indicative of at least one selected game type from the displayed list of available game types. In response to the player's selection, the proxy player server 40 displays a notification message to the player including a request for a total wager amount to be wagered on the selected games to be played by the proxy player server 40. The proxy player server 40 receives the total wager amount from the player and determines a per-game wager amount based on the total wager amount and the player-selected game type. The proxy player server 40 may also determine a number of games to be played based on the determined per-game wager amount and the selected game type.

The proxy player server 40 transmits a first request to play a first game of the player selected game-type to the game server 46. The request includes a first wager equal to the determined per-game wager amount. The game server 46 receives the request to play a first game, and, in response to receiving the first wager, generates an outcome of the first game, and determines an award based on the generated first game outcome and the received first wager. The game server 46 transmits the award and the outcome to the proxy player server 40 for display to the client computing device. The proxy player server 40 determines a total number of games played, and responsively transmits a second request to play a second game if the total number of games played is less than the determined number of games to be played. The second request includes a second wager that is equal to the determiner per-game wager amount. In response to receiving the second wager from the proxy player server 40, the game server 46 generates an outcome of the second game, determines an award associated with the second game outcome, and transmits the second game outcome and the associated award to the proxy player server 40 for display on the client computing device. In addition, the proxy player server 40 may determine a user profile associated with the unique identifier, wherein the user profile includes a collection of user-defined categories indicative of preferred game-types. The proxy player server 40 selects a plurality of game-types from the list of available game-types based on the user-defined categories and displays the selected preferred game-types in response to the user request.

In one embodiment, the proxy player server 40 may determine an amount previously wagered, and transmit the second play request if the amount previously wagered is less than the requested total wager amount. In addition, the proxy player server 40 may retrieve a wager amount associated with each game-type in the list of available game types from the game server 46, and select the game-types to be displayed on the client computing device 14 based on the requested total wager amount and the wager amounts associated with each game-type.

In one embodiment, the proxy player server 40 may also transmit a client computing device location verification request to the watchdog server 42. The request includes a unique location identifier associated with the client computing device. The watchdog server 42 determines if the unique location identifier is included in a collection of authorized location identifiers and responsively transmits a verification message if the received unique location identifier is included in the collection of authorized location identifiers. The proxy player server 40 displays the list of available game types upon receiving the verification message. In addition, the proxy player server 40 may also transmit a harmful activity verification request to the watchdog server 42, wherein request includes the received total wager amount and the selected game-type. The watchdog server 42 determines a number of play requests received over a predefined period of time and responsively transmits a harmful activity notification message to the proxy player server 40 if the number of play requests is greater than a predefined number of play requests over the predefined period of time.

In one embodiment, the proxy player server 40 transmits a funds verification request to the e-wallet server 44 that includes the total wager amount and the unique user identifier. The e-wallet server 44 determines a gaming account associated with the unique user identifier and an amount of available funds included in the gaming account. The e-wallet server 44 also determines if sufficient funds are available in the gaming account to fund the requested total wager amount and responsively transmits a verification message to the proxy player server 40 if sufficient funds are available in the gaming account to fund the requested total wager amount. The e-wallet server 44 may also transmit a funding request to the financial server 50 including the unique user identifier and a funding amount if the gaming account does not include sufficient funds. The funding amount may be determined as a function of the available gaming account funds and the requested total wager amount.

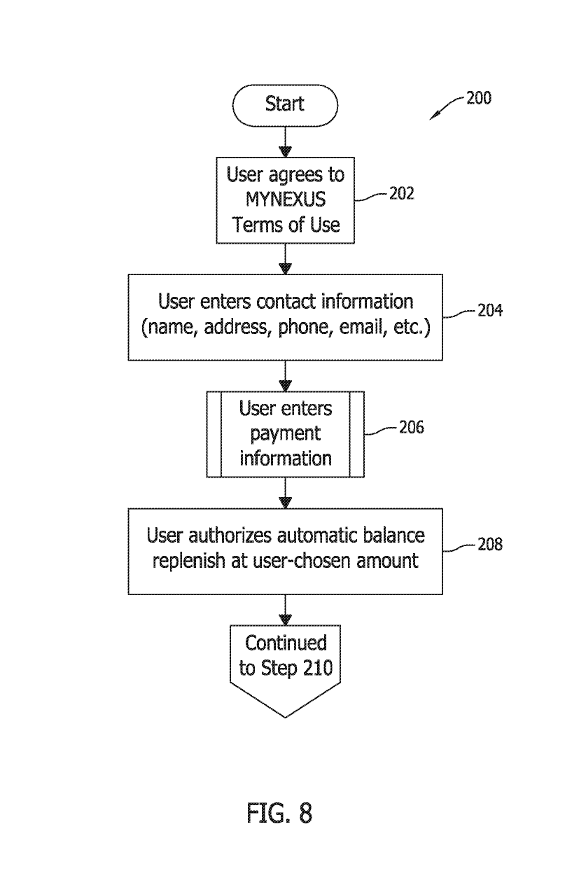

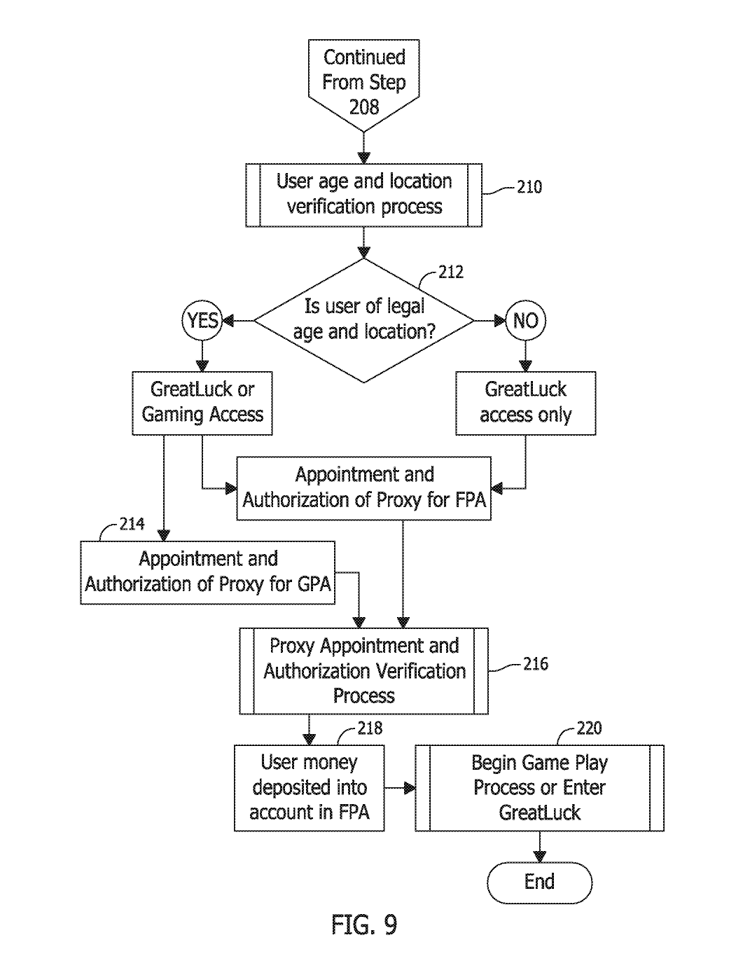

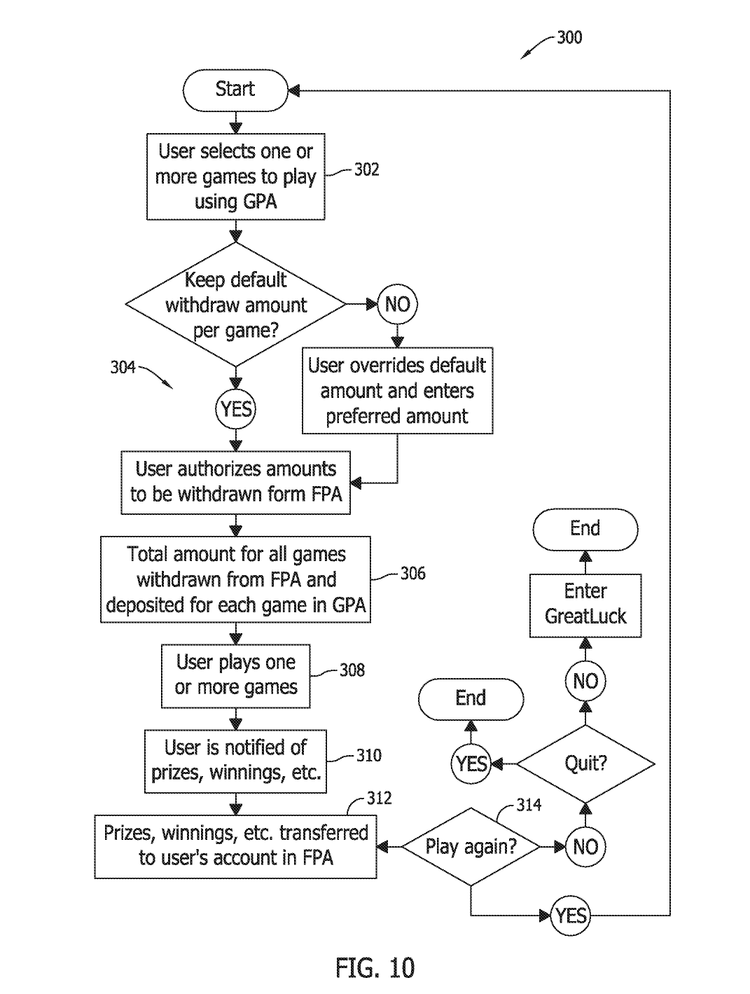

FIGS. 8 and 9 are flowcharts of a method 200 that may be used with the system 10 for allowing a player to create a user profile account to allow the player to request the proxy player server 40 to play games on behalf of the player. FIG. 10 is a flowchart of another method 300 that may be used with the system 10 for allowing a player to authorize the proxy player server 40 to play games on behalf of the player. Each method step may be performed independently of, or in combination with, other method steps. Portions of the methods 200 and 300 may be performed by any one of, or any combination of, the components of the system 10.

In the illustrated embodiment, in the method step 202, the system controller 36 displays a registration screen 70 (shown in FIG. 13) and allows a player view and acknowledge a terms of service associated with the use of the system 10 and allows the player to establish a user profile account. In method step 204, the system controller 36 receives a request from the player to establish a user profile account and responsively generates a corresponding user profile account and stores the user profile account in the database. Moreover, the system controller 36 displays a list of information required by the player in establishing the user profile account including, but not limited to, a name, an address, a phone number, an email, an age, a social security number, and/or any information that may be necessary to identify the user as a function of the user profile account.

In method step 206, the system controller 36 requests financial information from the player and receives payment information to enable the player to request the proxy player server 40 to purchase and play games on behalf of the player. For example, in one embodiment, the system controller 36 may receive payment information from the player and transmit the payment information to the e-wallet server 44 to verify the payment information and payment with the financial server 50. Upon verification and receipt of payment, the system controller 36 may update the user profile account to include the received payment. In method step 208, the system controller 36 allows the player to authorize the proxy player server 40 and/or the e-wallet server 44 to monitor the account balance associated with the corresponding user profile account and to automatically request payments from the financial server 50 as a function of the account balance. For example, in one embodiment, the system controller 36 may allow the player to establish a minimum account balance to be maintained in the user profile account, and allow the player to establish a replenishment amount that is authorized to be transferred from the financial server 50 to the e-wallet server 44 and/or to the user profile account when the minimum account balance is reached.

In the illustrated embodiment, in method step 210, the system controller 36 receives a request from the player to play a game and transmits the request, including information associated with the corresponding user profile account to the watchdog server 42. In addition, in method step 212, the system controller 36 receives a location identifier from the client computing device 14 being used by the player to access the system 12 and transmits the location identifier to the watchdog server 42. The watchdog server 42 verifies the location and age of the player and transmits a verification message to the system controller 36.

In method step 214, upon verifying the age and location of the player, the system controller 36 transmits an authorization request to the player to allow the player to authorize the proxy player server 40 to play a game on behalf of the player. In method step 216, the system controller 36 receives and verifies an authorization message from the player and assigns the proxy player server 40 to play games on behalf of the player.

In method step 218, the proxy player server 40 transmits a funds verification request including a total wager amount and the unique user identifier to the e-wallet server 44 to verify that sufficient funds are available in the gaming account associated with the player to play the games. In method step 220, upon verifying sufficient funds in the gaming account, the proxy player server 40 plays the games on behalf of the player and deposits any corresponding awards received from the games into the player's gaming account.

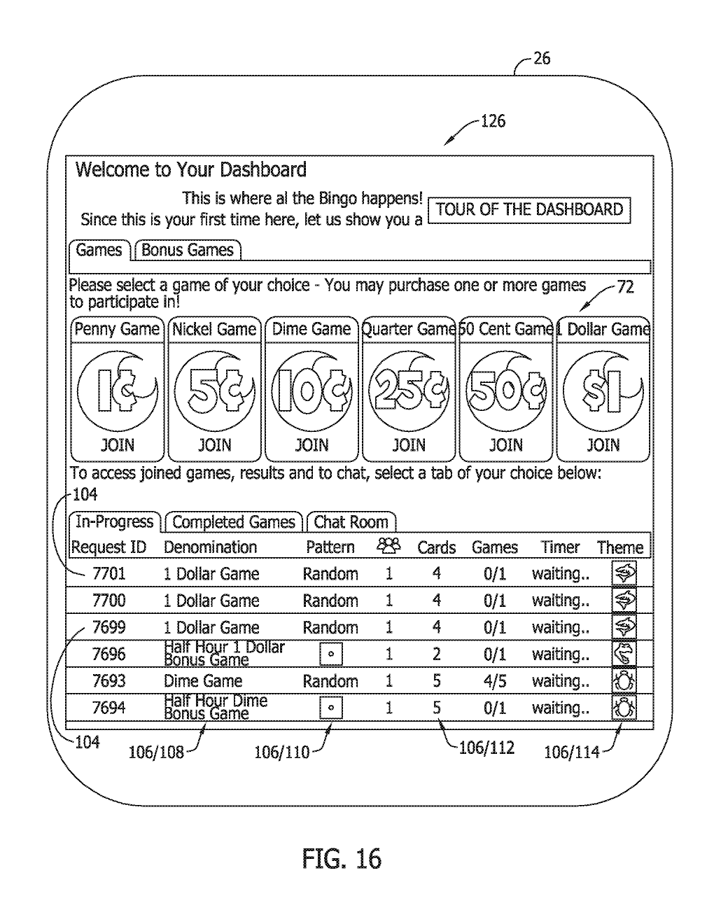

Referring to FIG. 10, in one embodiment, in method step 302, the proxy player server 40 displays a list of games 72 (shown in FIG. 16) and allows the player to select one or more games to be played by the proxy player server 40. In method step 302, the proxy player server 40 receives a verification message from the player for the amount of funds to be wagered on each of the player selected games. In one embodiment, the proxy player server 40 determines a default amount of wager per game based on the corresponding user profile account. In addition, the proxy player server 40 may allow the player to override any default wager amounts associated with the user profile account and allow the player to enter a wager per game amount.

In method steps 304 and 306, the proxy player server 40 receives an authorization to withdraw the wager amounts from the player gaming account, determines a total amount to be wagered based on the number of games selected by the player and the amount wagered per game, and deducts the total wager amount from the player gaming account.

In method step 308, the proxy player server 40 transmits a request to the game server 46 to play the player selected games, including the total wager amount. The game server 46 receives the request to play the games, generates an outcome associated with each game, determines an award associated with each game based on the generated game outcome and the associated wager, and transmits the awards and the outcomes to the proxy player server 40 for display to the player.

In method steps 310 and 312, the proxy player server 40 notifies the player of the game outcomes and the associated awards, if any, and transfers any awards to the player gaming account. In method step 314, the proxy player server 40 also allows the player to request additional games to be played on their behalf, and returns to method step 302 to allow the player to select any additional games.

Proxy Technical and Legal Standards. Minimum technical standards for random number generation via Proxy. This section provides minimum standards for random number generators (RNGs) used with the play of Class II games and for cryptography via the Proxy.

(a) Properties. All RNGs may produce output having the following cryptographic properties: (1) Statistical randomness; (2) Unpredictability; and (3) Non-repeatability.

(b) Statistical Randomness. (1) Numbers produced by an RNG may be statistically random individually and in the permutations and combination used in the application under the rules of the game. For example, if a Bingo game with 75 balls has a progressive winning pattern of the five numbers on the bottom of the card and the winning of this prize is defined to be the five numbers are matched in the first five balls drawn, the likelihood of each of the 75C5 combinations are to be verified to be statistically equal. (2) Numbers produced by an RNG may pass the statistical tests for randomness to a 99% confidence level, which may include: (i) Chi-square test; (ii) Equi-distribution (frequency) test; (iii) Gap test; (iv) Poker test; (v) Coupon collector's test; (vi) Permutation test; (vii) Run test (patterns of occurrences may not be recurrent); (viii) Spectral test; (ix) Serial correlation test potency and degree of serial correlation (outcomes may be independent from the previous game); and (x) Test on subsequences.

(c) Unpredictability. (1) It may not be feasible to predict future outputs of an RNG, even if the algorithm and the past sequence of outputs are known. (2) Unpredictability may be ensured by re-seeding or by continuously cycling the RNG, and by providing a sufficient number of RNG states for the applications supported. (i) Re-seeding may be used where the re-seeding input is at least as statistically random as, and independent of, the output of the RNG being re-seeded. (ii) The number of RNG states may be larger than the number of possible outcomes in the application for which the RNG is used by at least a factor of 108.

(d) Non-repeatability. The RNG may not reproduce the same output stream that it has produced before, nor may any two instances of an RNG produce the same stream as each other. This property may be ensured by initial seeding that comes from: (1) A source of “true” randomness, such as a hardware random noise generator; or (2) A combination of timestamps, parameters unique to a server or Electronic Player Station, previous RNG outputs, etc.

(e) General requirements. (1) Game software that calls an RNG to simulate an event of chance may immediately use the output returned in accordance with the game rules. (2) RNG outputs may not be arbitrarily discarded or selected. (3) Where a sequence of outputs is required, the whole of the sequence may be used in accordance with the game rules.

(f) Scaling algorithms and scaled numbers. An RNG that provides output scaled to given ranges may: (1) Meet the requirements of paragraphs (a) through (d) of this section and be independent and uniform over the range; (2) Provide numbers scaled to the ranges required by game rules, and notwithstanding the requirements of paragraph (e)(2) of this section, may discard numbers that do not map uniformly onto the required range but may use the first number in sequence which does map correctly to the range; (3) Be capable of producing every possible outcome of a game according to its rules; and (4) Use an unbiased algorithm. A scaling algorithm is considered to unbiased if the measured bias is no greater than 1 in 100 million.

(g) RNGs used for cryptography. (1) RNGs used for cryptography may: (i) Be separate from RNGs used for other purposes; (ii) Be accessible only by the components that implement the security functionality; (iii) Not weaken security by providing a point of attack on the security protocols that it supports; (iv) Have a number of states at least as great as the encryption strength—for example, an RNG using 128 bit encryption may have at least 2128 states; (v) Make use of an entropy source in its initial and ongoing seeding, unless a security protocol requires that a recipient's (pseudo) RNG supplied with correct key information reproduces the same sequence as the sender's RNG; and (vi) Be re-seeded at a rate that makes crypto-analytic attack impractical. (2) RNG components used for cryptography may notify callers in the event of a malfunction. (3) Security system components reliant on RNG outputs may cease to operate when a fault is detected in the operation of the RNG and security can no longer be assured.

Minimum technical standards applicable to the Proxy servers. This section provides standards applicable to all servers used with play of Class II games.

(a) General requirements. (1) Servers may authenticate all communications as coming from an enrolled client machine. (2) Servers may only process gaming transactions from games approved by the tribal gaming regulatory authority. (3) Servers may be able to enroll and un-enroll client machines for gaming. (4) Servers may be able to enable and disable specific client machines for gaming. (5) Servers may ensure that only enrolled, enabled client machines participate in gaming. (6) The default condition for new client machines may be un-enrolled and disabled.

(b) Physical security. Servers may be housed in a secure, dedicated room or in a secure locked cabinet. Access may be restricted to persons authorized by the tribal gaming regulatory authority. Servers located on the casino floor may also meet the applicable requirements of §547.7.

(c) Logical/Software security. Nothing in this section may be construed to alter, repeal or limit the applicability of §542.16(a) of this chapter. Proxy servers used in the play of Class II games may also meet the following requirements: (1) Servers may use operating systems that have discretionary access controls and may be configured so that access controls are used to prevent unauthorized access to the operating system, programs, data, and peripherals. (2) Servers may be configured so that audit trails are maintained for login/authentication successes and failures. The following information may be recorded, if supported: (i) Date and time of the login attempt; (ii) Username supplied; and (iii) Success or failure. (3) Logins using system accounts (e.g. administrator, root, etc.) may be restricted to the console. Notwithstanding this, logins using system accounts may be made away from the console for the purpose of remote support, provided that such remote access meets the requirements of paragraph (c)(9) of this section. (4) Generic user accounts are prohibited. (5) Accounts may be restricted to authorized personnel, as specified by the tribal gaming regulatory authority. (6) Account passwords may only be transmitted in encrypted or hashed form meeting the requirements of §547.23(b) through (c). (7) Application passwords may be stored in an encrypted or hashed form meeting the requirements of §547.23(b) through (c). (8) Only software essential to the operation of the server may be loaded onto the server. (9) Remote access to enable dynamic debugging may be permitted by the tribal gaming regulatory authority pursuant to §542.16(e) of this chapter. To support this facility, servers may: (i) Provide a mechanism to enable and disable remote access, which may be disabled by default; and (ii) Log all successful and unsuccessful attempts at remote access. Nothing in this requirement may be construed to alter, repeal, or limit the applicability of §542.16(e)(1) of this chapter.

(d) Game record information. The server may store the following records for each game played: (1) Client ID; (2) Game start time and date; (3) Game identifier (version); (4) Game end time; (5) Total amount bet by all participants in game; (6) Total amount won by all participants in game; and (7) Final game result, including progressive prizes awarded and, for bingo, game number and numbers or designations drawn, in the order drawn.

(e) Significant events. The server may store the following significant events: (1) Server shutdown; (2) Server startup; (3) Gaming application startup; (4) Gaming application shutdown; (5) Client enrolled; (6) Client un-enrolled; (7) Client enabled; (8) Client disabled; (9) Client tamper detection; (10) Client signature check and result; (11) Client application restart; (12) Client application download; (13) Server parameter change; (14) Client parameter change; (15) Game created; (16) Game enable; (17) Game disable; (18) Game deleted; (19) Any instance of an aborted game; (20) Large (jackpot) win; (21) Large win (jackpot) approved/rejected; (22) Progressive parameter change; (23) Progressive created; (24) Progressive enabled; (25) Progressive disabled; (26) Progressive deleted; (27) Progressive win; (28) Progressive win approved/rejected; (29) Client doors open; (30) Client doors closed; (31) Client hopper refill; (32) Client hand-pay; (33) Data-link level connection between client and server broken. This requirement does not refer to temporary perturbations of communications where “temporary” means a disruption of less than 10 seconds; and (34) Data-link level connection between client and server is established.

(f) Storage requirements. Game records, significant events, and remote access logs may be maintained for a period of one year from the date the games are played.

(g) Alternate storage requirements. Game records, significant events, and remote access logs may be kept in an archived manner, on the server or elsewhere, provided that the information reconciles across all forms of replicated storage and that the information can be produced within 24 hours upon request. In any event, game records and significant events for the previous 72 hours may be immediately accessible.

(h) Servers acting as progressive controllers. This paragraph (h) applies to progressive controllers, or servers acting as progressive controllers, used with the play of Class II games. (1) Modification of progressive jackpot parameters may be secure. Such parameters include, at a minimum: (i) Increment value; (ii) Secondary pool increment(s); (iii) Reset amount(s); (iv) Maximum value(s); and (v) Identity of participating Electronic Player Stations. (2) No parameters may be modified for an active progressive jackpot unless the jackpot has been won, or as otherwise authorized by the tribal gaming regulatory authority. (3) If the tribal gaming regulatory authority authorizes modification before a progressive jackpot is won, the server or controller may: (i) Halt the operation of the progressive jackpot(s); (ii) Allow the parameter modifications; and then (iii) Restart the progressive jackpot(s). (4) No progressive jackpot may be returned to its reset amount before it is won except as authorized by the tribal gaming regulatory authority. In any event, no progressive jackpot may be reset before it is won unless the accumulated jackpot amount is transferred to another active progressive jackpot. (5) The server or other progressive controller may provide a means of creating a progressive balancing report for each progressive it controls. At a minimum, that report may provide balancing of the changes in coin-in meters for all participating Electronic Player Stations versus current progressive jackpot amount(s), plus progressive jackpots won. In addition, the report may account for, and not be made inaccurate by, unusual events such as: (i) Electronic Player Station critical memory clears; (ii) Modification, alteration, or deletion of progressive jackpots. (iii) Offline equipment; or (iv) Multiple site jackpots.

Minimum technical standards applicable both to clients and servers or to client-server implementations generally. This section provides minimum software standards common both to servers and clients, wherever located, and used in the play of Class II games. It also provides minimum standards for client-server implementations used in the play of Class II games.

(a) Client enable/disable requirements. (1) Electronic Player Stations may be in a disabled state following: (i) An application start or restart; (ii) A system start; and (iii) A system start from a standby, sleep, or hibernating mode. (2) Electronic Player Stations may remain in the disabled state until they receive an “enable” command from the server. (3) Electronic Player Stations may not immediately enable on receipt of a server “enable” command if a door open or other disabled state is still present when the enable instruction is received from the server, but may enable itself after all alarms are cleared.

(b) Automatic operation of programs. Software used with play of Class II games may automatically restart, without the need for operator intervention, when the computer on which they operate starts or restarts.

(c) Load requirements. (1) Under high or maximum loads: (i) The server or client may not provide misleading information to players. (ii) Information stored in the client or server may not become corrupted. (iii) Random number generators may continue to perform correctly. (iv) Game outcome decisions may not be affected except for speed degradation. (2) The client-server system may function correctly after it has recovered from an excessive load. (3) Recovery from excessive load may involve a system restart.

(d) Memory requirements. (1) Servers and clients may implement memory in any form, including random access memory of any kind, writeable flash, memory sticks, PCMCIA memory, and writable disks. (2) Memory data storage may be capable of preserving its contents for at least 90 days with power removed. (3) Memory backup power sources, which may be rechargeable or non-rechargeable, may meet the following conditions: (i) May have the ability to fully recharge within 24 hours, if rechargeable; and (ii) May have a life span of at least five years. (4) Random access memory that uses an off-chip battery backup may provide a method for the Electronic Player Station software to: (i) Check for battery low/battery fail conditions on every power up and, at a minimum, every 24 hours; and (ii) Interpret and act upon a battery low/battery fail condition.

(e) Network requirements. (1) Network infrastructure may ensure that only gaming-related equipment can make a data-link layer connection to server or clients. For the purposes of this subsection, “gaming-related equipment” means: (i) Casino monitoring systems; (ii) Cashless gaming systems; (iii) Voucher payment systems; (iv) Player tracking systems; (v) Progressive jackpot systems or controllers; or (vi) Any other gaming-related equipment approved by the tribal gaming regulatory authority. (2) If servers or clients are also connected to non-gaming computers, data may only transfer from the servers and clients to the non-gaming equipment. This may be implemented through: (i) Internal controls approved by the tribal gaming regulatory authority; and (ii) Configuration of firewall devices so that only the servers and clients can establish the connection to be used for the data transfer. (3) The network infrastructure may report an event each time a data-link level connection is established or broken to a client or server. These events may be raised at the server, casino monitoring system or network control terminal.

(f) Communications protocol requirements. The following requirements apply to the communications within the client-server domain: (1) Extensible protocols are permitted provided that any recipient may explicitly reject options, commands, and responses that it does not support. (2) The communications protocol may be designed to support delivery of all data, including after a restart of a system component. The protocol is not required to support delivery in the case of a total failure of a system before all data is sent. (3) The protocol may ensure the correct delivery of data to the application in the order that the data was sent and without loss or duplication. (4) The communications protocol may be designed and implemented so there is no noticeable degradation of data integrity at bit error rates of 1 in 10.

(g) Failure/recovery requirements. (1) Client-server domains used in the play of Class II games may provide a level of redundancy and a means of recovery such that the occurrence of any of the following will not lead to the loss of, or prevent recovery of, data stored in critical memory, including credit balance: (i) Catastrophic client failure or failure of primary client components such as hard disks or other primary storage devices; (ii) Catastrophic server failure, including replacement of server hardware or primary components; and (iii) Total power failure, unless duplicated uninterruptible power supplies (UPSs) of requisite capacity are part of the domain specifications.

Description Interface between Proxy Process and Game Play

(1.) FPA and GPA are set up:

(a.) The interface between these two entities are described in earlier outline.

(2.) Game play.

(a.) User enters Great Luck (MY) or Club KaChing (CK) directly.

(b.) User want to play a CK Class II Game. (i.) If registered user then proceed. (1.) Registration, FPA and GPA information accessible at either location. (a.) Information help in MY database. (ii.) If not then registration required

(c.) Registered User then selects desired CK Class II game(s) to be played (i.) FPA and GPA are turned on (ii.) User indicates the level of but in for the game(s) (denomination to be played) by clicking on designated button (1.) GPA authorized to draw from FPA (2.) User only need do this again to change the level of buy in or when changing to different game(s) (iii.) User then clicks on the designated button authorizing GPA to play the game(s) at buy in level designated above (1.) GPA plays the game (a.) Multiple games may be authorized for simultaneous play (2.) Results are automatically displayed to User's device via an entertaining display (3.) User may click on designated button to play the game again or may select to change the game(s), but in level or leach the CK Class II game area completely (see below) (a.) Key—The User may make a decision about playing or not for every game by authorizing the GPA

(3.) User decides to leave CK Class II game area

(a.) GPA transfers the balance of funds (winnings less buy ins) to FPA (i.) Verification for accounting, send notice to User, set record-keeping

(4.) At every step record-keeping may be maintained that documents adherence to Proxy agreements and process

(5.) Interface with the CMS, PMS and other back of house accounting are a strict requirement

Online Gaming System

The Great Luck solution for online casino construction is a complex software system enabling interactive casino games to be played in real-time mode. The system supports either “real money play” or “free play” gaming variants. Both modes are configurable through the administration system panel.

The system is simple to use and manage yet extremely powerful and sophisticated. The system features: incorporate stability, scalability, multi-functionality and reliability. It also offers full customization, game resizing, HD resolution support, 3D support, high-speed query processing and system performance.

Great Luck will be incorporating a Server Based Gaming architecture, or SBG. This is a standard similarly employed by the Electronic Gaming Machines (EGMs). An SBG system includes a central system and gaming terminals, which connect to the central system that may be operated locally, over a LAN, or over large geographical areas by way of a WAN, such as the Internet, that incorporates play either directly by a client or through a proxy.

In such a system, Great Luck will be running multiple instances of an application server. This is common for almost all network-based services. A recurring example is an http/web service that is required to handle a considerable number of clients simultaneously. All major online shops, casinos, portals, social networks, etc., are based on large server arrays that split the load efficiently, allowing hundreds of thousands of users to enjoy the web application without noticeable or adverse impact on performance.

The Proxy component houses all game server logic and is located in the hosting environment at a remote location. For example, a poker player is only dealt cards that have been “shuffled” and “dealt” by the remote Proxy server at the physical hosted location. All gaming logic, including random number generation, is executed at the remote location and where called for, through the proxy. The player only sees the results as they are generated from the remote Proxy location. All events are securely authenticated by the Server. The Game Server is the final authority on all game transactions at the Proxy location.

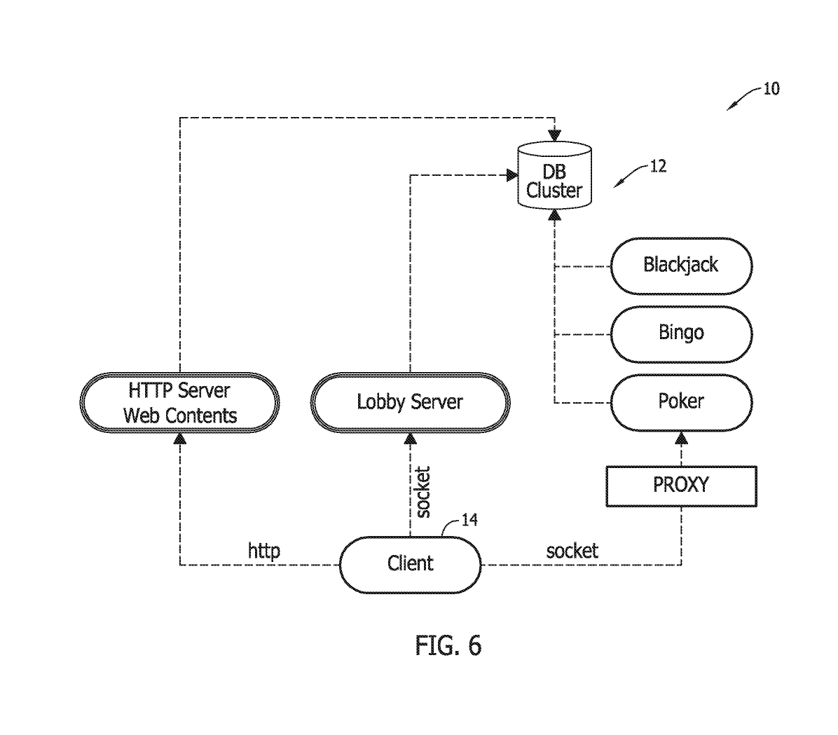

FIG. 6 illustrates in a simplistic way how this is done, e.g., one or more load balancers are exposed as the main entry point for the website which in turn will find a free web server inside the array and direct the user request to that machine. At this point, the content is generated by the application server and delivered to the client via the Proxy component.

The Server Based Gaming system represents a paradigm shift from both standalone terminals and SSG because game logic and Random Number Generation (RNG) reside on the server in an SBG system.

Frequently mentioned benefits of SBG include: Fast and secure games deployment; Architecture and security based on G2S and S2S standards; Game logic executed on game server; Support for standard casino games, multiplayer and community games; Data storage on remote server system; Provision of account module and precise reporting; Progressives, bonus, cashless, ticketing functionalities; System integration based on standard protocols such as G2S, S2S and SAS; Fast and efficient games development and no lock single vendor; Open game API for game running logic on server and game presentation running on client; and Higher security, due to the fact that the RNG and game logic cannot be manipulated at individual game terminals.

Security and Logic

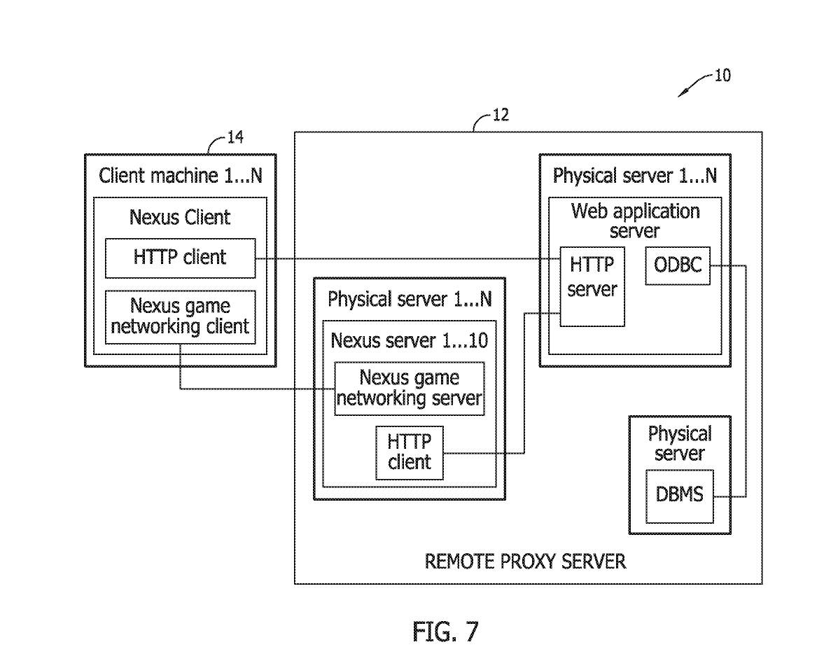

The security and logic of the software games is managed and calculated within the server side code. All the data sent to the server is carefully analyzed and used for its set purposes. The game logic that insures that the application is safe and profitable is located on the Proxy side of each game. Odds, cards, symbols, numbers are calculated carefully on the server depending on the current casino bank and the win percentages, making it nearly impossible for anyone to trick the casino. After calculating the data on the server, the outcome is sent to the player's location and displayed in an entertaining format. Based on the data provided, the client game decodes and analyzes the data and displays the proper animations and icons (e.g., In the SLOT games, when SPIN button is pressed, data like bet lines and total bet is sent to the server, then the server calculates the odds for the player and the symbols that the slot may display and any winnings due the player because of these symbols are credited to the player's account accordingly. Then the data is then sent back to the game server and the game server confirms that the proper icons for the symbols and win calculations where used and applied and then updates win value and credit value in the game). The software is secured against web attacks like database injections, XSS injections, login theft, file system attacks, brute force hacking and other attack methods using proper coding that analyzes and checks that all the data coming from the games and from the users is correct and secure. (See FIG. 7).

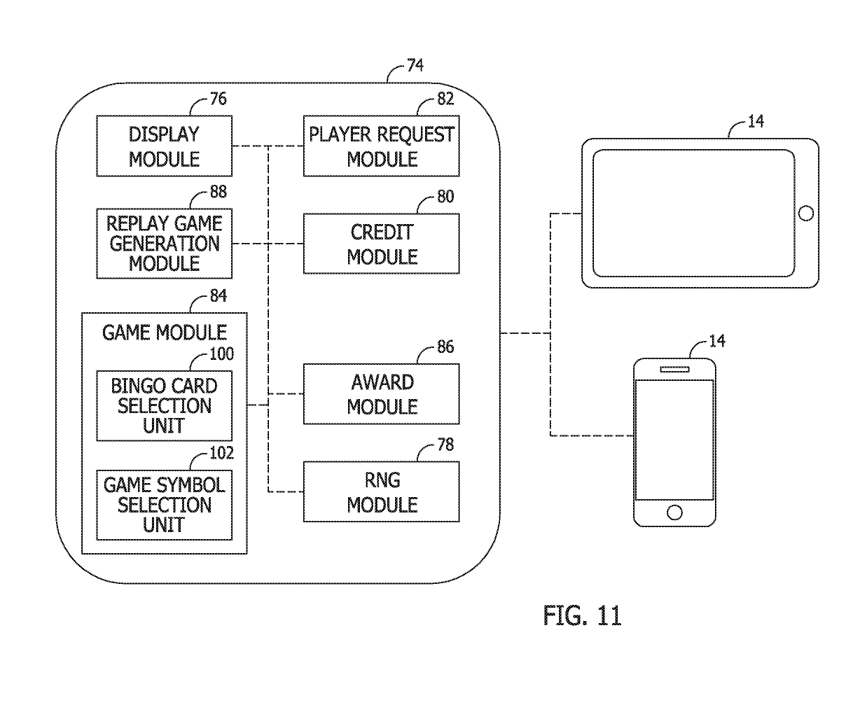

FIG. 11 is schematic view of the proxy player server 40. In the illustrated embodiment, the proxy player server 40 includes a proxy controller 74 that includes a display module 76, a random-number generator (RNG) module 78, a credit module 80, a player request module 82, a game module 84, an award module 86, and a game replay generation module 88.

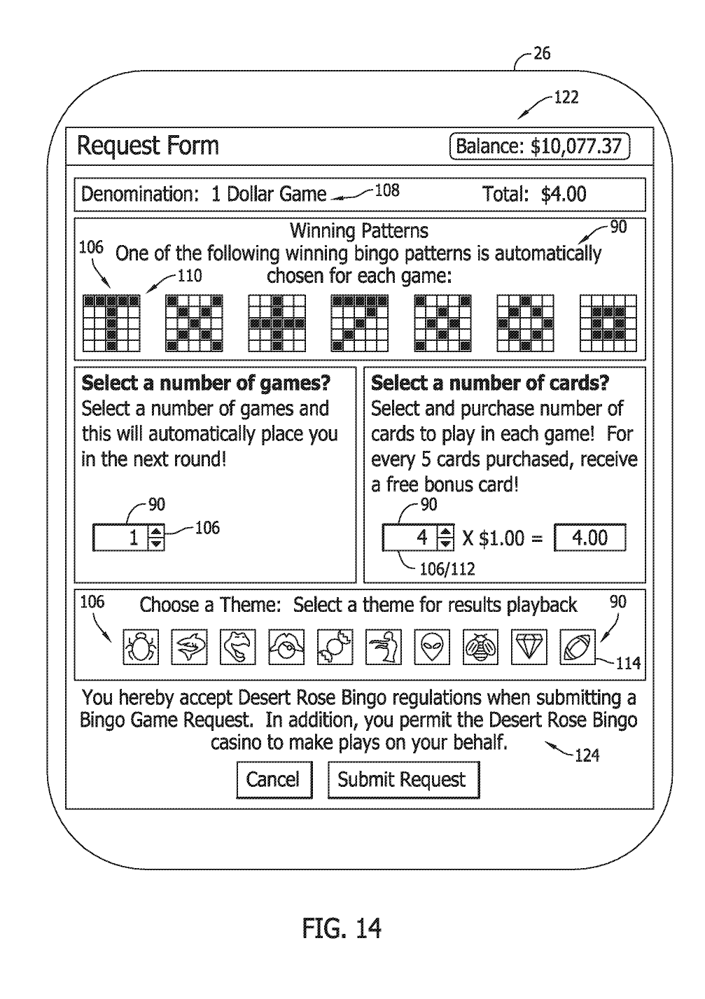

The display module 76 controls the display device 26 to display various images on the graphical interfaces preferably by using computer graphics and image data stored in the database 60. More specifically, the display module 76 controls images being displayed in on the display device 26 by using computer graphics and the image data. In the illustrated embodiment, the display module 76 also displays a plurality of user selection areas 90 (shown in FIG. 14) within the graphical interfaces that correspond to specific operations that may be initiated by the user.

The credit module 80 communicates with the e-wallet server 44 to manage the amount of player's credits available for use in playing a game. The credit module 80 receives a user selection indicative of a request from a client computing device 14 to play a game including an amount of game credits associated with the selected game. The credit module 80 sends a verification message to the e-wallet server 44 including a unique user identifier and a game credit amount associated with the requested game play. The e-wallet server 44 identifies the user profile account and the gaming account associated with the unique user identifier and determines if sufficient game credits are available in the gaming account as a function of the user request. If the e-wallet server 44 determines sufficient game credits are available in the user profile account, the e-wallet server 44 sends a verification message to the credit module 80 and deducts a corresponding amount of game credits from the gaming account. If the e-wallet server 44 determines that the gaming account does not include a sufficient amount of game credits, the credit module 80 displays a message on the client computing device 14 requesting the user to purchase additional game credits corresponding to the request. In addition, the credit module 80 may also display an amount of game credits included in the gaming account that are available for use in playing and/or wagering on the games.

The game module 84 includes a game program for use in playing a game based on game preferences received from a player. The game module 84 receives game information from the game list included in the database 60 and performs various functions and calculations to play the game according to a set of predetermined game rules. More specifically, the game module 84 retrieves game elements from the database 60 and generates an outcome of the game based on the predetermined game rules and the corresponding game request record being received from the player.

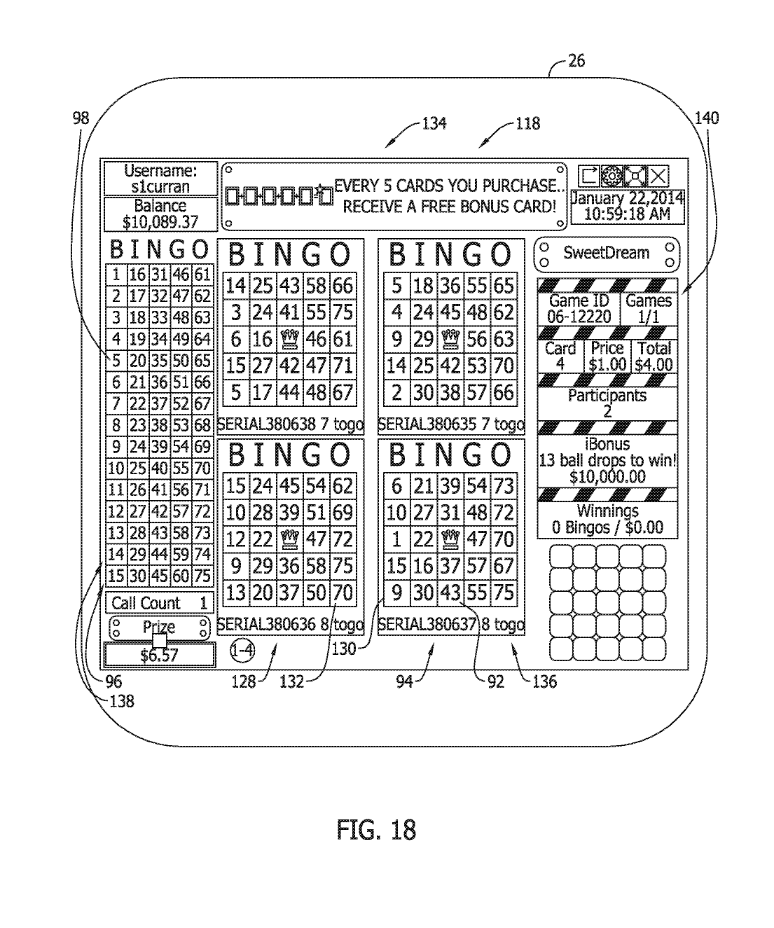

The RNG module 78 generates and outputs random numbers to the game module 84 for use in playing the game 72. In addition, the game module 84 may use random numbers generated by the RNG module 78 to determine if a winning condition has occurred in the outcome of the game, and to determine whether or not to provide an award to a player. For example, if the game is the bingo-type game, the game module 84 uses the RNG module 78 to randomly select one or more bingo cards 92 (shown in FIG. 18) including a plurality of bingo symbols 94 being selected from a predefined set of game symbols 96. In addition, the game module 84 uses the RNG module 78 to randomly select a plurality of draw symbols 98 from the predefined set of game symbols 96 during a symbol draw. The game module 84 compares the draw symbols 98 such as, for example, bingo numbers selected during the draw with the bingo symbols 94 and/or numbers displayed in the selected bingo cards 92 to determine a number of bingo symbols 94 and/or numbers matching the randomly selected draw symbols 98. In one embodiment, the game module 84 may randomly select a winning bingo pattern associated with each game, and determine an outcome of each bingo game as a function of the randomly selected winning pattern.

In the illustrated embodiment, the game module 84 includes a bingo card selection unit 100 and a game symbol selection unit 102. The bingo card selection unit 100 is configured to randomly select one or more bingo cards from a list of bingo cards being stored in the database 60 for use by the proxy player server 40 in playing a game on behalf of the player. Each bingo card may include randomly selected bingo symbols 94 that are selected from a predefined set of game symbols.

In the illustrated embodiment, the game symbol selection unit 102 is configured to randomly select draw symbols 98 from a predefined set of game symbols 96 for use in the bingo-type game 72. For example, in one embodiment, the game symbol selection unit 102 may be configured to randomly select a plurality of draw symbols 98 from the predefined set of bingo symbols 94 for use in the bingo-type game 72 and determine if each randomly selected draw symbol 98 matches one or more bingo symbols 94 associated with the selected bingo cards 92.

In the illustrated embodiment, the player request module 82 is configured to receive a request to play a game from a player, generate a game request record 104 (shown in FIG. 16) associated with the player as a function of the received request, and store the game request record 104 in the database 60. The player request module 82 transmits the game request record 104 to the game module 84 for use in generating a game and playing the game on behalf of the player as a function of the received game request record 104. In one embodiment, the player initiated request includes an authorization by the player to allow the proxy controller 74 to play the game on behalf of the player. In the illustrated embodiment, the game request record 104 includes one or more request categories 106 including, but not limited to, a game denomination 108, a winning bingo pattern 110, a number of bingo cards 112, and/or a game theme 114. In one embodiment, the player request module 82 may also determine if the generated game request record 104 matches one or more other game request records 104 being stored in the database 60 and being associated with a different player. Moreover, the player request module 82 may compare each stored game request record 104 as a function of the each of the corresponding request categories 106 and responsively determine any matching game request records 104.

In the illustrated embodiment, the game module 84 receives a first request to play a game from a first player and generates and stores a game request record associated with the first player as a function of the received first request. The game module 84 also determines if the generated game request record matches at least one stored game request record being associated with a second player as a function of the corresponding request categories, and initiates play of the game if the first player request matches the second player request. The game module 84 may also play the game on behalf of the first player and the second player. For example, in one embodiment, the first player may submit a first game request to the proxy player server 40 to play a game having a game denomination equal to $1.00. The proxy controller 74 generates a first game request record associated with the first game request. The proxy controller 74 determines if the database includes another game request record being associated with another player that includes a similar game denomination, i.e. $1.00, and initiates the game on behalf of each of the players having matching game requests. In the illustrated embodiment, upon receiving the first game request, the proxy controller 74 may initiate a waiting period including a predetermined period of time in which to receive another matching request from another player before initiating the game. In addition, if a matching game request record is not received within the waiting period, the proxy controller 74 may notify the first player that a matching game request has not been received, including displaying the selection categories of other stored game request records, and may request the first player to modify one or more selection categories included in the first game request to match a stored game request record such that a game may be initiated and played. Moreover, in one embodiment, the first game request may include an authorization from the first player to modify one or more selection categories to facilitate matching the first game request with another stored game request record.

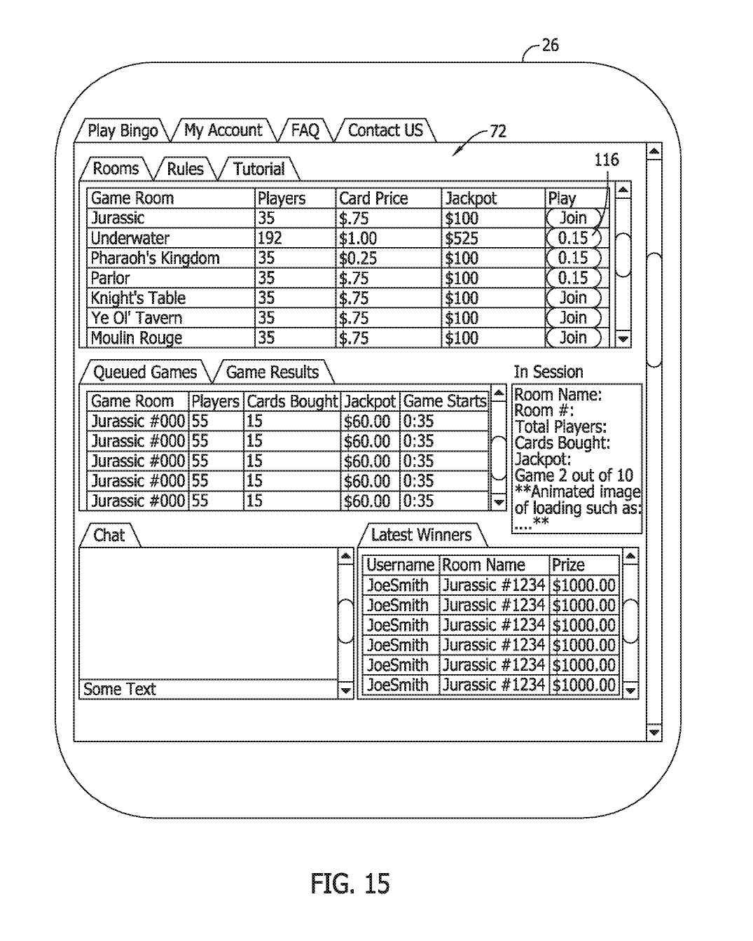

In one embodiment, the proxy controller 74 may determine a total number of matched game requests, determine if the total number of matched game requests is equal to a predetermined number of matched game requests, and responsively initiate a game if the total number of matched requests is greater than or equal to the predetermined number of matched game requests. In another embodiment, the proxy controller 74 may also generate a list including a plurality of games 72 (shown in FIGS. 15 and 16) with each game being associated with one or more request categories. The proxy controller 74 may assign each game request record to at least one of the plurality of games as a function of the corresponding request category. Each game request record that is assigned to a corresponding game may be associated with a different player. In addition, the proxy controller 74 may also determine if the number of players being assigned to a corresponding game is equal to a predefined number of players and responsively initiate the game upon detecting a minimum number of assigned players. Moreover, the proxy controller 74 may initiate the game upon detecting a maximum number of assigned players. In one embodiment, upon detecting the minimum number of assigned players, the proxy controller 74 may initiate a sign-up period countdown 116 (shown in FIGS. 15 and 16) including a countdown of a predefined period of time in which additional players may submit requests to play the game. The proxy controller 74 may also display the countdown period to the players to notify the players of the limited period of time remaining in which to submit a game play request.

In the illustrated embodiment, the game module 84 plays the bingo-type game 72 on behalf of the player, determines an outcome of the bingo-type game 72, and stores the game outcome in the database 60. Moreover, the game module 84 determines the game outcome including any symbol matches included on the selected bingo cards assigned to the player and transmits the game outcome to the award module 86. The award module 86 compares the game outcome with winning combinations stored in a winning combination table to determine if the symbol matches include a winning outcome that is associated with a type of award.

The game replay generation module 88 generates a game replay 118 (shown in FIG. 18) that is indicative of the generated game outcome and updates the game request record 104 to include the corresponding game replay 118. The game replay 118 includes images and animations that are generated to simulate the game played by the proxy controller 74. In one embodiment, the game replay generation module 88 generates the game replay 118 as a function of a game theme 114 being selected by a player. Moreover, the game replay generation module 88 may generate the game replay 118 based on the game theme 114 associated with the corresponding game request record 104. In the illustrated embodiment, each game theme 114 may include a different game appearance, different game symbols, different symbol arrangements, symbol images, game graphics, game colors, and/or different game sounds from other game themes 114.

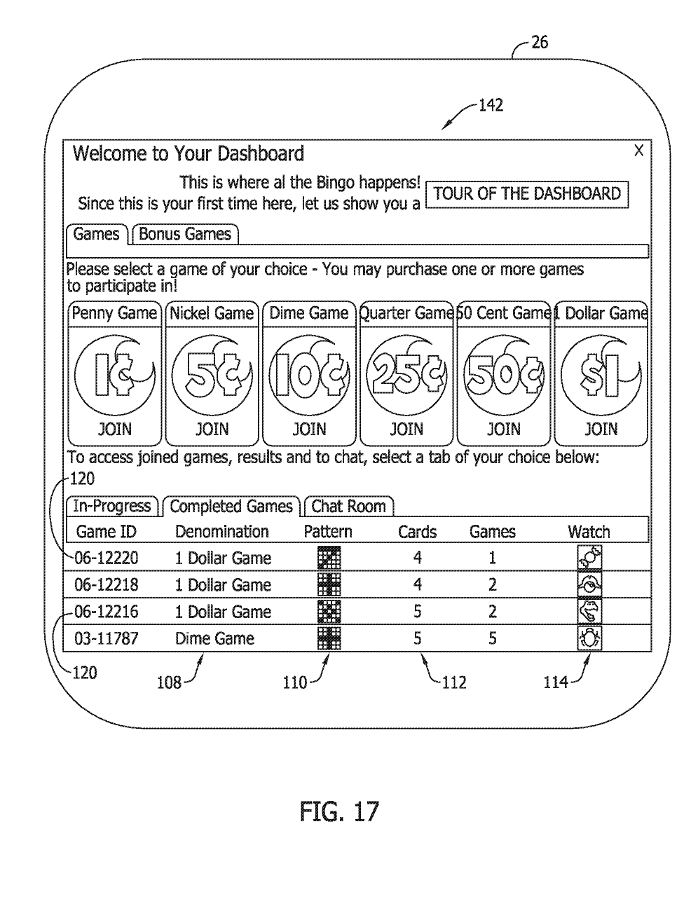

In the illustrated embodiment, the proxy controller 74 displays a list of completed games 120 to the player (shown in FIG. 17) and allows the player to submit a request to display the game replays 118. The game replay generation module 88 responsively displays the game replay 118 to the player in response to the received player request.

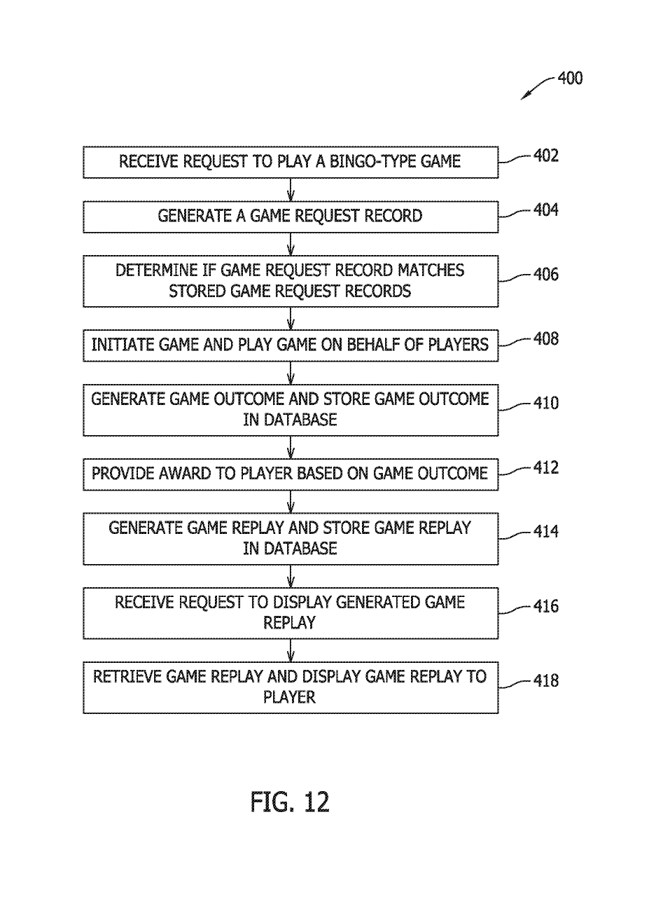

FIG. 12 is a flowchart of a method 400 that may be used with the system 10 for allowing a player to request a proxy player server 40 to play a game on behalf of the player and playing a game on behalf of players. Each method step may be performed independently of, or in combination with, other method steps. Portions of the method 400 may be performed by any one of, or any combination of, the components of the system 10. FIGS. 13-18 are graphical displays of a graphic interface screens that may be used with the method 400. In the illustrated embodiment, entertaining graphical displays for amusement purposes are presented by the client computing device 14 via the display device 26 (shown in FIG. 1) and may receive input (e.g., selections and/or entries) via the user input device 28 (shown in FIG. 1). For example, in one embodiment, a selection may be received via user input device 28 of the client computing device 14 and may be transmitted by the client computing device 14 to the server system 12 via the network.

In the illustrated embodiment, in the method step 402, the proxy controller 74 receives a request from a player to play the bingo-type game 72 from a client computing device 14. In one embodiment, the player may submit the request by accessing a website via the web/vpn server 38. In another embodiment, the player may access a mobile website via the cellular network 18. In addition, in one embodiment, the method step 402 may include receiving, by the proxy controller 74, a unique user identifier to validate the request to display the bingo-type game 72. More specifically, the display module 76 may display a login screen (not shown) on the client computing device 14 to request the unique user identifier such as, for example, requesting a username and/or password. The proxy controller 74 may receive the unique user identifier and transmits a validation request including the user credentials to the watchdog server 42. The watchdog server 42 compares the received unique user identifier with the collection of unique user identifiers contained in the user profile program to validate the unique user identifier, and responsively sends a validation message to the proxy controller 74 if the received unique user identifier is included in the user profile program. Upon receiving the validation message from the watchdog server 42, the proxy controller 74 displays a listing of available games from the game list. In addition, in one embodiment, if the received user identifier is not included in the user profile program, the proxy controller 74 display the registration screen 70 and prompt the user to establish a user account. In addition, in one embodiment, method step 402 may also include receiving a wager from the player and/or receiving a request to purchase a play of the game with game credits from the corresponding user profile account.

In method step 404, the proxy controller 74 generates a game request record 104 associated with the player as a function of the received request and stores the game request record 104 in the database 60. In the illustrated embodiment, the proxy controller 74 displays a game request screen 122 (shown in FIG. 14) that enables the player to submit the game request to the proxy controller 74 via the client computing device 14. The game request screen 122 includes a plurality of request categories 106 associated with the game request including, but not limited to, a game denomination 108, a number of games to be played, a number of bingo-cards 112 to be played per game, a replay game theme 114, and/or a proxy authorization 124. In one embodiment, the player selects a value associated with each request category 106 and transmits the request to the proxy controller 74. Upon receiving the player request, the proxy controller 74 generates a game request record 104 including the player selected values associated with each request category 106.

In one embodiment, in method step 404, the proxy controller 74 may display a plurality of games 72 (shown in FIGS. 15 and 16) from the list of games stored in the database and allow the player to select one or more games 72. The proxy controller 74 may also responsively display the game request screen 122 for each selected game 72 to allow the player to submit a game request associated with each selected game including player preferences indicative of the selected request categories 106. In another embodiment, upon receiving a player's selection of a game, the proxy controller 74 may identify preauthorized player preferences included in a corresponding user profile account and generate the game request record 104 including request categories 106 determined as a function of the preauthorized player preferences. In one embodiment, the proxy controller 74 may display a game progress screen 126 (shown in FIG. 16) indicative of the game request records 104 associated with the player. The game progress screen 126 may include each game request record 104 associated with the player including a value of each request category 106 associated with a corresponding game request record 104 and a status of a corresponding game. The status may include, but is not limited to, an indication of whether the game has been played, is waiting to be, needs additional players, and/or is a corresponding game replay 118 has been generated.

In the illustrated embodiment, the proxy controller 74 allows the player to select a game denomination and allows the player to select one or more games to be played with the selected game denomination. In one embodiment, the proxy controller 74 may generate a game request record 104 corresponding to each of the number of games requested by the player.

In method step 406, the proxy controller 74 determines if the generated game request record 104 matches at least one other game request record 104 being stored in the database 60. In method step 408, the proxy controller 74 responsively initiates a game and plays the game on behalf of the corresponding matched players. The proxy controller 74 generates an outcome of the game, and stores the game outcome in the database 60. In the illustrated embodiment, the proxy controller 74 determines if the generated game request record 104 matches at least one stored game request record 104 as a function of at least one request category 106 associated with the corresponding game request records 104.

For example, in one embodiment, the game request records 104 may be provided as in the following table and include request categories including a player identification, a game denomination, a number of bingo cards per game, a bingo pattern, and/or a replay game theme. The following table is for illustrative purposes only and does not limit the scope of the present invention.

| Game Request | | Game | No. of | Bingo | Replay | Purchase |
|---|---|---|---|---|---|---|
| Record | Player ID | Denomination | Bingo Cards | Pattern | Game Theme | Amount |
| 1 | Player 1 | $1.00 | 4 | Pattern 2 | Theme 2 | $4.00 |
| 2 | Player 1 | $0.05 | 5 | Pattern 1 | Theme 2 | $0.25 |
| 3 | Player 2 | $1.00 | 2 | Pattern 3 | Theme 1 | $2.00 |
| 4 | Player 2 | $0.10 | 4 | Pattern 3 | Theme 3 | $0.40 |
| 5 | Player 3 | $0.10 | 5 | Pattern 1 | Theme 1 | $0.50 |

The first column represents the game request record identification. The second column represents the player identification number corresponding to the player associated with the game request record. The third through seventh columns represent selection categories associated with the game request submitted by the player. The third column represents the game denomination selected by the player. The fourth column represents a number of bingo cards requested by the player to be played in the corresponding game. The fifth column represents the winning bingo pattern selected by the player. The sixth column represents the replay game theme selected by the player for use in generating the game replay. The seventh column represents the total wager amount determined as a function of the selected game denomination and the number of bingo cards selected.

In the illustrated embodiment, upon receiving a game request from a player, the proxy controller 74 generates a game request record including the player ID, game denomination, number of bingo cards, winning bingo pattern, replay game theme, and total wager amount. For example, upon receiving a first request from a first player, such as, for example, Player 1, the proxy controller 74 generates Game Request Record 1 corresponding to the received request. The proxy controller 74 determines if the request category values included in the Game Request Record 1 matches any of the request category values associated with any other Game Request Record being stored in the database 60, and responsively initiates a game being played on behalf of the players associated with the matched game request records. For example, the proxy controller 74 may match Game Request Record 1 associated with Player 1 with Game Request Record 2 associated with Player 2 because each corresponding game request record includes a $1.00 game denomination. In addition, the proxy controller 74 may initiate a game on behalf of Player 1 and Player 2 based on Game Request Record 1 and Game Request Record 2, respectively. Moreover, the proxy controller 74 may generate an outcome of the game and provides an award to Player 1 and/or Player 2 as a function of the game outcome and the corresponding game request records.

In one embodiment, the proxy controller 74 may also determine a total number of matched game requests with each of the matched game requests being associated with a different player, and determine if the total number of matched game requests is equal to a predetermined number of matched game requests. For example, in one embodiment, the proxy controller 74 may require a minimum number of matched players before initiating a game. Upon matching a minimum number of game request records, the proxy controller 74 may responsively generate the outcome of the game if the total number of matched game requests is equal to the predefined number of matched game requests. In addition, the proxy controller 74 may require a maximum number of matched players, and may initiate the game upon matching a maximum number of game request records 104.

In one embodiment, the proxy controller 74 may generate a list including a plurality of games 72 with each game being associated with at least one request category 106. For example, the proxy controller 74 may generate a list including games having a plurality of game denominations including, for example, a $0.01 denomination, a $0.05 denomination, $0.10 denomination, a $0.25 denomination, $0.50 denomination, and/or $1.00 denomination. The proxy controller 74 may assign each game request record 104 to at least one of the plurality of games 72 as a function of the corresponding request category. The proxy controller 74 may also determine if a number of players being assigned to the corresponding game is equal to a predefined number of players and responsively generate an outcome of the corresponding game and providing an award to at least one of the assigned players as a function of the outcome. For example, in one embodiment, the proxy controller 74 may receive a game request including a request to play a $1.00 game denomination. The proxy controller may assigned the received request to a corresponding $1.00 game and determine if the number of game request records assigned to the $1.00 game is equal to the predefined number of players. Upon determining the $1.00 game includes the predefined number of players, the proxy controller 74 may responsively initiate the game and play the game on behalf of the assigned players.

In the illustrated embodiment, in method step 410, the proxy controller 74 generates an outcome of the game and provides an award to the player as a function of the game outcome and the total wager amount associated with the game. The game module 84 determines a number of bingo cards being associated with the player as a function of the corresponding game request record 104 and randomly selects a corresponding number of bingo cards 92 from the collection of bingo cards contained in the database 60 and assigns the selected bingo cards to the first player. Each of the bingo cards 92 includes a plurality of bingo symbols 94 that are selected from a predefined set of game symbols 96. In one embodiment, the proxy controller 74 may assign one or more additional bingo cards 92 to the player as a function of the number of bingo cards purchased by the player as a bonus. During game play, the proxy controller 74 conducts a symbol draw operation and randomly selects a plurality of draw symbols 98 from the predefined set of game symbols 96. The proxy controller 74 determines, for each bingo card 92, if each one of the plurality of draw symbols 98 matches a corresponding one of the plurality of bingo symbols 94, and determines a combination formed by each of the matched bingo symbols 94. The proxy controller 74 may also determine, for each bingo card 92, if the formed combination is a winning combination and responsively provide an award to the corresponding player.

For example, in one embodiment, the proxy controller 74 may initiate a game including a first player and a second player. The proxy controller 74 randomly selects a first bingo card and assigns the first bingo card to the first player, and randomly selects a second bingo card and assigns the second bingo card to the second player. The proxy controller 74 conducts the symbol draw and randomly selects a plurality of draw symbols 98 and determines if any of the draw symbols 98 matched the bingo symbols 94 associated with the first and second bingo cards, and provides an award as a function of the matched symbols.

In the illustrated embodiment, each bingo card 92 includes a plurality of bingo symbols 94 being arranged in a grid 128 including a plurality of rows 130 and a plurality of columns 132. In one embodiment, the bingo card 92 may include bingo symbols 94 being along a plurality of rows 130 and columns 132. For example, a bingo card 92 may include bingo symbols 94 being arranged in 5 rows 130 and 5 columns 132 in a “5×5” arrangement. Alternatively, any number of bingo symbol 94 may be arranged in any suitable grid arrangement including, for example, 20 bingo symbols 94 arranged in a 4×5 arrangement, 9 bingo symbols 94 arranged in a 3×3 arrangement, and/or any suitable number of bingo symbols 94 arranged in any suitable row 130 and column 132 combination to enable the proxy controller 74 to function as described herein. In addition, the grid 128 may be displayed with a plurality of shapes such as, for example, a rectangle, a square, a diamond, a circle, and/or any suitable shape.

In the illustrated embodiment, each bingo symbol 94 and draw symbol 98 is selected from a predefined set of game symbols 96. In one embodiment, the game symbols 96 may include numbers and/or a combination of letters and numbers.

In the illustrated embodiment, during game play, the proxy controller 74 identifies a pattern being formed by the matched bingo symbols 94, determines if the formed pattern matches a predefined winning bingo pattern, and responsively provides an award to the first player and/or second player. In one embodiment, the proxy controller 74 may randomly select a winning pattern associated with the initiated game and provide an award if the pattern being formed by the matched bingo symbols 94 matches the randomly selected bingo pattern. In another embodiment, the proxy controller 74 selects the winning bingo pattern based on a corresponding game request record 104. For example, the proxy controller 74 may allow the player to select a winning bingo pattern on the game request screen 122 and generate a game request record 104 including the player selected winning bingo pattern. The proxy controller 74 may also generate the game outcome and provide an award to the player as a function of the player selected winning pattern.

In the illustrated embodiment, the game module 84 stores data indicative of the game outcome in the database 60 for use in generated a game replay 118. The game replay 118 includes images and animations to simulate the game outcome generated by the game module 84. In one embodiment, the game module 84 stores data indicative of each bingo card 92 played on behalf of the player during the game, the matched bingo symbols 94, the patterns formed by the matched bingo symbols 94, the draw symbols 98 selected during the game 72, and the order in which the draw symbols 98 were selected.

In method step 412, the award module 86 provides the player an award if the determined combination of matched bingo symbols 94 forms a winning combination of symbols. The award module 86 may provide an award to the player based on the combination of matched bingo symbols 94, the wager, and a predetermined paytable. In general, the term “award” may be a payout, in terms of credits or money. Thus, the proxy controller 74 may award a regular payout in response to the outcome of the game. However, it should be noted that the term award may also refer to other types of awards, including prizes, e.g., meals, show tickets, etc. . . . , as well as in-game awards, such as free games, bonus symbols, and/or special game modes.

In one embodiment, the award module 86 may detect a number of players being included in the game and determine a number of awards that are available during the game based on the number of players being included in the game. In addition, the award module 86 may determine a wager amount associated with each game request record 104 being assigned to a game, and determine a total wager amount associated with the game as a function of each wager amount included in each assigned game request record 104. The award module 86 may also determine an amount of award available to players during the game as a function of the total wager amount associated with the game. During game play, the proxy controller 74 may determine the outcome of each bingo card 92 and terminate the game when the determined number of awards has been awarded during the round.

In method step 414, the proxy controller 74 generates a game replay 118 that is indicative of the generated game outcome and assigns the game replay 118 to a corresponding game request record 104. Moreover, the proxy controller 74 generates a game replay 118 for each player included in the game based on the player selected game theme 114. The proxy controller 74 stores the game replay 118 in the database 60 and allows the player to request the game replay 118 to be displayed by the proxy controller 74 to allow the player to view the results of the played game. By generating a game replay 118, the proxy controller 74 allows the player to view the outcome of a game that has been previously played by the proxy controller 74 on behalf of the player.

In the illustrated embodiment, the game replay 118 includes audio and video images of the game previously played by the proxy controller 74 on behalf of the player. The game replay 118 is stored in the database 60 to be accessed and viewed by the player after the proxy controller 74 has generated the game outcome and provided the player an award. The game replay 118 presents an entertaining graphical display including game images and animations indicative of the game outcome to the player. In the illustrated embodiment, the game replay generation module 88 generates a game replay 118 based on the game theme 114 selected by the player and associated with the corresponding game request record 104. In one embodiment, the player may select a game theme 114 from a list of game themes included in the database 60. Each game theme 114 includes images and animations associated with the corresponding game theme 114 such as, for example, images and animations associated with a Egyptian game theme, a shark game theme, a dinosaur game theme, a candy game theme (shown in FIG. 14) and/or any suitable game theme that enables the game replay generation module 88 to generate a game replay 118.

In the illustrated embodiment, the game replay generation module 88 generates a game replay 118 including symbol images and animations indicative of the game outcome for use in displaying the game replay 118 on a game replay screen 134 (shown in FIG. 18). In one embodiment, as shown in FIG. 18, the game replay generation module 88 may generate a game replay 118 including a bingo-type game 72. However, it should be noted that the proxy controller 74 may generate and display a game replay 118 indicative of any type of game upon which a player could make a wager and/or purchase a game play including, but not limited to, a slot game, a blackjack game, a video poker game, or any suitable audio/video images and animations that facilitate notifying the player of the game outcome and any associated award.

In general, during method step 414, the game replay generation module 88 generates the game replay 118 including a bingo-type game 72 being displayed with a bingo card area 136, a symbol draw area 138, and a player information area 140. The bingo card area 136 includes one or more bingo cards 92 included in the game. The number of bingo cards 92 being displayed in the game replay 118 are equal to the number of bingo cards selected by the game module 84 and played on behalf of the player. Each bingo card 92 is displayed with the corresponding bingo symbols 94 being displayed in the grid 128. The symbol draw area 138 includes the set of game symbols 96. The player information area 140 includes information associated with the generated game including, but not limited to, a game ID, a number of bingo cards 92 played in the game, a number of players associated with the game, a number of awards available to the player during the game, and/or the winning pattern associated with the game. In one embodiment, the game replay generation module 88 may also display the amount of funds included in the corresponding gaming account at the time the game was being played by the proxy controller 74.

In the illustrated embodiment, the game replay generation module 88 retrieves data indicative of the bingo cards 92 played on behalf of the player including the corresponding bingo symbols 94 from the database 60. The game replay generation module 88 generates an image of each bingo card 92 and displays the bingo cards 92 in the bingo card area 136. The game replay generation module 88 may also retrieves the game symbols 96 associated with the game and displays the game symbols 96 in the symbol draw area 138. In the illustrated embodiment, the game replay generation module 88 retrieves data indicative of the matched bingo symbols 94 associated with each bingo card 92 and the order of draw symbol 98 selected by the game module 84. The game replay generation module 88 then generates a simulated symbol draw operation and generates animation indicative of the symbol draw operation conducted by the game module 84 and sequentially displays each selected draw symbol 98 in the symbol draw area 138 to simulate a symbol draw operation. The game replay generation module 88 also retrieves data indicative of the matched bingo symbols 94 including the formed patterns and generates animation including sequentially marking and/or “daubing” the matched bingo symbols 94 as the corresponding draw symbols 98 are selected and displayed. In addition, the game replay generation module 88 generates an award animation that is displayed when a corresponding winning combination is achieved and/or a corresponding award is provided. In this manner, the game replay generation module 88 generates a game replay 118 that simulates the game outcome generated by the game module 84. Many variations to the above described general play of a bingo-type game fall within the scope of the present invention. In the illustrated embodiment, the game replay 118 is assigned to the corresponding game request record 104 and/or user profile account to allow the player to select and display the game replay 118 after the game has been played by the proxy controller 74.

In method step 416, the proxy controller 74 receives a request to display a game replay 118 and responsively retrieves the corresponding game replay 118 from the database 60 and displays the game replay 118 to the player. In one embodiment, the proxy controller 74 may display a competed games screen 142 (shown in FIG. 17) that includes a list of completed games including each corresponding game request record 104 and game replay 118. The proxy controller 74 allows the player to select a completed game 120 from the list of completed games 120 and, in method step 418, responsively retrieves the selected game replay 118 and displays the game replay 118 associated with the selected completed game 120.

The above-described systems and methods overcome at least some disadvantages of known systems by providing system capable to receive a request from a player to play a game, responsively play the game on behalf of the player, and generate a game replay that is indicative of the played game. Moreover, the system allows the player to select the game replay to view a simulation of the game that has been previously played on behalf of the player. In addition, the system may allow a player to submit a game request that includes a plurality of player game preferences, match the received game request with a game request associated with another player, and initiate a game that includes the matched players. By providing a proxy player server that plays a game on behalf of a player and generates a game replay indicative of the played game, the player is allowed to remotely play Class II games with real money wagers via a mobile device and/or a website, and the excitement and interest of the player is increased, thus the amount of revenue received from the player is increased.

Exemplary embodiments of a system and method for playing game on behalf of a player with proxy player servers are described above in detail. The system and method are not limited to the specific embodiments described herein, but rather, components of the system and/or steps of the method may be utilized independently and separately from other components and/or steps described herein. For example, the system may also be used in combination with other wagering systems and methods, and is not limited to practice with only the system as described herein. Rather, an exemplary embodiment can be implemented and utilized in connection with many other wagering applications.

A controller, computing device, or computer, such as described herein, includes at least one or more processors or processing units and a system memory. The controller typically also includes at least some form of computer readable media. By way of example and not limitation, computer readable media may include computer storage media and communication media. Computer storage media may include volatile and nonvolatile, removable and non-removable media implemented in any method or technology that enables storage of information, such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, a processor, as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

In some embodiments, application programming interface (API) includes a protocol intended to be used as an interface by software components to communicate with each other. An API may include specifications for routines, data structures, object classes, and variables. An API specification may include, but is not limited to an International Standard such as POSIX, vendor documentation such as the Microsoft Windows API, the libraries of a programming language, e.g. Standard Template Library in C++ or Java API.

In some embodiments, a database, as described herein, includes any collection of data including hierarchical databases, relational databases, flat file databases, object-relational databases, object oriented databases, and any other structured collection of records or data that is stored in a computer system. The above examples are exemplary only, and thus are not intended to limit in any way the definition and/or meaning of the term database. Examples of databases include, but are not limited to only including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Other aspects and features of the present invention can be obtained from a study of the drawings, the disclosure, and the appended claims. The invention may be practiced otherwise than as specifically described within the scope of the appended claims. It should also be noted, that the steps and/or functions listed within the appended claims, notwithstanding the order of which steps and/or functions are listed therein, are not limited to any specific order of operation.

Although specific features of various embodiments of the invention may be shown in some drawings and not in others, this is for convenience only. In accordance with the principles of the invention, any feature of a drawing may be referenced and/or claimed in combination with any feature of any other drawing.

What is claimed is:

1. A proxy system for playing a game on behalf of a player, comprising:
a database for storing a plurality of game request records; and
a proxy controller coupled to the database, the proxy controller configured to:
receive, from a player via a user computing device, a first request to play a game;
generate an outcome of the game and store the outcome in the database;
receive a second request from the player to display a replay of the stored outcome; and
generate a game replay indicative of the generated game outcome and display the game replay to the player in response to the second request.

2. A proxy system in accordance with claim 1, wherein the first request includes an authorization by the player to allow the proxy controller to play the game on behalf of the player.

3. A proxy system in accordance with claim 1, the proxy controller configured to:
generate a game request record associated with the first player as a function of the received first request and store the game request record in the database, the game request record including at least one request category;
determine if the generated game request record matches at least one of the stored game request record being associated with a second player as a function of the at least one request category and responsively generate the outcome of the game; and
provide an award to at least one of the first player and the second player as a function of the outcome and the game request records associated with the first and the second players, respectively.

4. A proxy system in accordance with claim 3, wherein the database includes a list including a plurality of games, each game being associated with at least one request category, the proxy controller configured to:
assign each game request record to at least one of the plurality of games as a function of the corresponding request category, each game request record assigned to a corresponding game being associated with a different player;
determine if a number of players being assigned to the corresponding game is equal to a predefined number of players; and
responsively generate an outcome of the corresponding game and providing an award to at least one of the assigned players as a function of the outcome.

5. A proxy system in accordance with claim 3, the proxy controller configured to:
determine a total number of matched game requests, each of the matched game requests being associated with a different player;
determine if the total number of matched game requests is equal to a predetermined number of matched game requests; and
responsively generate the outcome of the game if the total number of matched game requests is equal to a predefined number of matched game requests.

6. A proxy system in accordance with claim 5, wherein the predefined number of matched game requests includes at least one of a minimum number of players and a maximum number of players.

7. A system in accordance with claim 1, wherein the at least one request category includes at least one of a game denomination, a winning bingo pattern, and a number of bingo cards.

8. A proxy system in accordance with claim 1, wherein the database includes a collection of bingo cards, the proxy controller configured to:
determine a number of bingo cards being associated with the first player as a function of the first player game request record;
randomly select a corresponding number of bingo cards from the collection of bingo cards and assigning the selected bingo cards to the first player; and
provide an award to the first player as a function of the game outcome and the selected bingo cards.

9. A proxy system in accordance with claim 8, the proxy controller configured to:
assign at least one bingo card to each of the first player and the second player, each bingo card including a plurality of bingo symbols being selected from a predefined set of game symbols;
randomly select a plurality of draw symbols from the predefined set of game symbols;
determine, for each bingo card, if each one of the plurality of draw symbols matches a corresponding one of the plurality of bingo symbols and determine a combination formed by each of the matched bingo symbols; and
determine, for each bingo card, if the formed combination is a winning combination and responsively providing an award to the corresponding player.

10. A proxy system in accordance with claim 9, the proxy controller configured to:
randomly select a winning pattern associated with the game;
determine, for each bingo card, if the combination formed by each of the matched bingo symbols forms the winning pattern and responsively provide an award to the corresponding player.

11. A method of playing a game on behalf of a player via a proxy system, the proxy system including a proxy controller and a database, the method including the steps of:
receiving, from a player via a user computing device, a first request to play a game;
generating an outcome of the game and store the outcome in the database;
receiving a second request from the player to display a replay of the stored outcome; and
generating a game replay indicative of the generated game outcome and display the game replay to the player in response to the second request.

12. A method in accordance with claim 11, wherein the first request includes an authorization by the player to allow the proxy controller to play the game on behalf of the player.

13. A method in accordance with claim 11 including the steps of:
generating a game request record associated with the first player as a function of the received first request and storing the game request record in a database, the game request record including at least one request category;
determining if the generated game request record matches at least one stored game request record being associated with a second player as a function of the at least one request category; and
responsively generating an outcome of the game; and
providing an award to at least one of the first player and the second player as a function of the outcome and the game request records associated with the first and the second players, respectively.

14. A method in accordance with claim 13, including the steps of:
generating a list including a plurality of games, each game being associated with at least one request category;
assigning each game request record to at least one of the plurality of games as a function of the corresponding request category, each game request record assigned to a corresponding game being associated with a different player;
determining if a number of players being assigned to the corresponding game is equal to a predefined number of players; and
responsively generating an outcome of the corresponding game and providing an award to at least one of the assigned players as a function of the outcome.

15. A method in accordance with claim 13, including the steps of:
determining a total number of matched game requests, each of the matched game requests being associated with a different player;
determining if the total number of matched game requests is equal to a predetermined number of matched game requests; and
responsively generating the outcome of the game if the total number of matched game requests is equal to a predefined number of matched game requests.

16. A method in accordance with claim 15, wherein the predefined number of matched game requests includes at least one of a minimum number of players and a maximum number of players.

17. A method in accordance with claim 11, wherein the at least one request category includes at least one of a game denomination, a winning bingo pattern, and a number of bingo cards.

18. A method in accordance with claim 11, wherein the database includes a collection of bingo cards, the method including the steps of:
determining a number of bingo cards being associated with the first player as a function of the first player game request record;
randomly selecting a corresponding number of bingo cards from the collection of bingo cards and assigning the selected bingo cards to the first player; and
providing an award to the first player as a function of the game outcome and the selected bingo cards.

19. A method in accordance with claim 18, including the steps of:
assigning at least one bingo card to each of the first player and the second player, each bingo card including a plurality of bingo symbols being selected from a predefined set of game symbols;
randomly selecting a plurality of draw symbols from the predefined set of game symbols;
determining, for each bingo card, if each one of the plurality of draw symbols matches a corresponding one of the plurality of bingo symbols and determining a combination formed by each of the matched bingo symbols; and
determining, for each bingo card, if the formed combination is a winning combination and responsively providing an award to the corresponding player.

20. A method in accordance with claim 19, including the steps of:
randomly selecting a winning pattern associated with the game;
determining, for each bingo card, if the combination formed by each of the matched bingo symbols forms the winning pattern and responsively providing an award to the corresponding player.

21. One or more non-transitory computer-readable storage media, having computer-executable instructions embodied thereon, wherein when executed by at least one processor, the computer-executable instructions cause the processor to:
receive, from a player via a user computing device, a first request to play a game;
generate an outcome of the game and store the outcome in the database;
receive a second request from the player to display a replay of the stored outcome; and
generate a game replay indicative of the generated game outcome and display the game replay to the player in response to the second request.

22. The one or more computer-readable storage media according to claim 21, wherein the first request includes an authorization by the player to allow the proxy controller to play the game on behalf of the player.

23. The one or more computer-readable storage media according to claim 21, wherein when executed by at least one processor, the computer-executable instructions cause the processor to:
generate a game request record associated with the first player as a function of the received first request and store the game request record in a database, the game request record including at least one request category;
determine if the generated game request record matches at least one of the stored game request record being associated with a second player as a function of the at least one request category and responsively generate an outcome of the game; and
provide an award to at least one of the first player and the second player as a function of the outcome and the game request records associated with the first and the second players, respectively.

24. The one or more computer-readable storage media according to claim 23, wherein the database includes a list including a plurality of games, each game being associated with at least one request category, the computer-executable instructions cause the processor to:
assign each game request record to at least one of the plurality of games as a function of the corresponding request category, each game request record assigned to a corresponding game being associated with a different player;
determine if a number of players being assigned to the corresponding game is equal to a predefined number of players; and
responsively generate an outcome of the corresponding game and providing an award to at least one of the assigned players as a function of the outcome.

25. The one or more computer-readable storage media according to claim 23, wherein when executed by at least one processor, the computer-executable instructions cause the processor to:
determine a total number of matched game requests, each of the matched game requests being associated with a different player;
determine if the total number of matched game requests is equal to a predetermined number of matched game requests; and
responsively generate the outcome of the game if the total number of matched game requests is equal to a predefined number of matched game requests.

26. The one or more computer-readable storage media according to claim 25, wherein the predefined number of matched game requests includes at least one of a minimum number of players and a maximum number of players.

27. The one or more computer-readable storage media according to claim 21, wherein the at least one request category includes at least one of a game denomination, a winning bingo pattern, and a number of bingo cards.

28. The one or more computer-readable storage media according to claim 21, wherein when executed by at least one processor, the computer-executable instructions cause the processor to:
determine a number of bingo cards being associated with the first player as a function of the first player game request record;
randomly select a corresponding number of bingo cards from the collection of bingo cards and assigning the selected bingo cards to the first player; and
provide an award to the first player as a function of the game outcome and the selected bingo cards.

29. The one or more computer-readable storage media according to claim 28, wherein when executed by at least one processor, the computer-executable instructions cause the processor to:
assign at least one bingo card to each of the first player and the second player, each bingo card including a plurality of bingo symbols being selected from a predefined set of game symbols;
randomly select a plurality of draw symbols from the predefined set of game symbols;
determine, for each bingo card, if each one of the plurality of draw symbols matches a corresponding one of the plurality of bingo symbols and determine a combination formed by each of the matched bingo symbols; and
determine, for each bingo card, if the formed combination is a winning combination and responsively providing an award to the corresponding player.

30. The one or more computer-readable storage media according to claim 29, wherein when executed by at least one processor, the computer-executable instructions cause the processor to:
randomly select a winning pattern associated with the game;
determine, for each bingo card, if the combination formed by each of the matched bingo symbols forms the winning pattern and responsively provide an award to the corresponding player.
